(19) United States
(12) Patent Application Publication
(10) Pub. No.: US 2015/0132742 A1
(43) Pub. Date: May 14, 2015

(54) Microfluidic Devices Formed From Hydrophobic Paper

(71) Applicant: President and Fellows of Harvard College, Cambridge, MA (US)

(72) Inventors: Martin Mwangi Thuo, Watertown, MA (US); Ramses V. Martinez, Somerville, MA (US); Ana C. Glavan, Cambridge, MA (US); Wenjie Lan, Somerville, MA (US); Xinyu Liu, Montreal (CA); Jean-Francis Bloch, Grieres (FR); George M. Whitesides, Newton, MA (US)

(21) Appl. No.: 14/404,120

(22) PCT Filed: Jun. 3, 2013
(86) PCT No.: PCT/US13/43882

§ 371 Date: Nov. 26, 2014

Related U.S. Application Data
(60) Provisional application No. 61/784,907, filed on Mar. 14, 2013.
(60) Provisional application No. 61/654,639, filed on Jun. 1, 2012.

(51) Int. Cl. B01L 3/00

(52) U.S. Cl. CPC B01L 3/502707; B01L 3/5085; B01L 3/502738; B01L 3/502784; B01L 2300/126; B01L 2300/165; B01L 2300/0816; B01L 2300/0829
USPC 435/5; 435/283.1; 435/29; 435/287.1; 436/86; 436/71; 436/94; 422/552; 422/502; 264/134

(57) ABSTRACT

Microfluidic devices fabricated from paper that has been covalently modified to increase its hydrophobicity, as well as methods of making and using thereof are provided herein. The devices are typically small, portable, flexible, and both easy and inexpensive to fabricate. Microfluidic devices contain a network of microfluidic components, including microfluidic channels, microfluidic chambers, microwells, or combinations thereof, designed to carry, store, mix, react, and/or analyze liquid samples. The microfluidic channels may be open channels, closed channels, or combinations thereof. The microfluidic devices may be used to detect and/or quantify an analyte, such as a small molecules, proteins, lipids polysaccharides, nucleic acids, prokaryotic cells, eukaryotic cells, particles, viruses, metal ions, and combinations thereof.

### RELATED APPLICATIONS

This application claims the benefit of priority under 35 C.F.R. §119(e) to U.S. Application No. 61/654,639, filed Jun. 1, 2012, entitled “Microfluidic Devices Formed form Hydrophobic Paper”, and to U.S. Application No. 61/784,907, filed Mar. 14, 2013, entitled “Microfluidic Devices Formed form Hydrophobic Paper”, the contents of which are incorporated in their entirety by reference.

### STATEMENT OF GOVERNMENT SUPPORT

This work was supported by government support under DE-FG02-00ER45852 awarded by United States Department of Energy. The United States Government may have certain rights to this invention.

### INCORPORATION BY REFERENCE

All patents, patent applications and publications cited herein are hereby incorporated by reference in their entirety in order to more fully describe the state of the art as known to those skilled therein as of the date of the invention described herein.

### FIELD OF THE INVENTION

The present invention is related to microfluidic devices that are fabricated from low cost cellulosic substrates that have been covalently modified to increase their hydrophobicity.

### BACKGROUND OF THE INVENTION

Microfluidic devices have attracted intense interest for use in a variety of applications. In particular, the ability of microfluidic systems to analyze small volumes of liquid renders them well suited for many bio-analytical applications.

In spite of their tremendous promise, microfluidic devices have yet to be widely employed in many potential applications. The most widely used technology for the fabrication of microfluidic devices—based on polydimethylsiloxane (PDMS) and soft-lithography—is cost prohibitive and too technically demanding for use in many low-cost applications, such as food testing. In addition, many traditional microfluidic devices must be interfaced with complex and/or expensive instrumentation, dramatically limiting the potential use of microfluidics in point-of-care diagnostic applications, particularly in developing countries.

Microfluidic systems based on hydrophilic paper have emerged in recent years as a low-cost, environmentally friendly alternative to conventional elastomer or polymer-based microfluidics. These systems (micro-paper based analytical devices, or μPads) use capillarity to transport fluid passively through hydrophilic ‘closed channels’ defined by non-covalently patterning hydrophobic barriers on a porous hydrophilic substrate using SU-8 and photolithography, wax printing, or PDMS dissolved in hexanes. The resulting microfluidic devices contain closed microfluidic channels that rely on capillarity to transport fluid samples passively through these hydrophilic closed channels.

While existing paper-based microfluidic devices are attractive in their fast prototyping and ease of use, their reliance on wicking for transfer of fluid by through closed microfluidic channels can limit their ability to analyze some types of samples, including samples containing large macromolecules, suspended cells, and particles. In addition, because these devices rely exclusively on closed microfluidic channels, they do not exhibit some of the advantageous properties characteristic of open channel microfluidic devices, including laminar flow, efficient heat transfer, and low volume consumption.

Therefore, it is an object of the invention to provide economical microfluidic devices that include a wider variety of microfluidic features, including open microfluidic channels, are fabricated from environmentally friendly materials, and are capable of carrying, storing, mixing, reacting, and/or analyzing liquid samples.

It is a further object of the invention to provide economical microfluidic devices that are fabricated from environmentally friendly materials, and are capable of carrying, storing, mixing, reacting, and/or analyzing liquid samples, including biological samples, which contain large macromolecules, suspended cells, and particles.

It is also an object of the invention to provide open channel microfluidic devices, closed channel microfluidic devices, microwells, and combinations thereof that are fabricated from a cellulosic substrate, such as paper, that has been covalently modified to increase its hydrophobicity, as well as methods of fabricating thereof.

### SUMMARY OF THE INVENTION

Microfluidic devices fabricated from paper that has been covalently modified to increase its hydrophobicity, as well as methods of making and using thereof are provided herein. The devices are typically small, portable, and both easy and inexpensive to fabricate.

By fabricating microfluidic devices from covalently modified paper, paper-based microfluidic devices containing a variety of microfluidic features, including open microfluidic channels, can be fabricated. Microfluidic devices can contain a network of microfluidic components, including microfluidic channels, microfluidic chambers, microwells, or combinations thereof, designed to carry, store, mix, react, and/or analyze liquid samples. Microfluidic devices include at least one fluid flow path, formed by one or more microfluidic components through which fluid flows during sample processing. In some cases, a single microfluidic device can include multiple fluid flow paths. In these instances, the plurality of fluid flow paths may be positioned in any convenient arrangement within the device, and may or may not intersect, depending on the device design.

The microfluidic devices are well suited for applications that require low Reynolds number pressure-driven flows in open channels—for example, multiphase flows involving drops or bubbles, or flows of complex fluids such as whole blood or colloidal suspensions that containing particulates. In addition, they address some of the limitations of conventional capillary driven devices, such as limited minimum feature sizes (e.g., channel widths are generally greater than 200 μm) and inefficient delivery of sample within the device (due to sample retention in the porous cellulose matrix, the volume that reaches the detection zones is usually less than 50% of the total volume within the device).

In some embodiments, one or more of the microfluidic channels in the microfluidic device are open channels. Open channels are conduits that contain a central void space through which fluid flows, and a bottom and side-walls formed from a cellulosic substrate that has been covalently modified to increase its hydrophobicity, such that the bottom and side-walls of the open channel are substantially impermeable to the fluid flowing through the open channel.

Open channels may have varied dimensions depending on the applications for the microfluidic device. In certain embodiments, the open channel has a width, measured as the distance between the two side walls of the microfluidic channel at the surface of the cellulosic substrate, of less than about 3 mm, more preferably less than about 1 mm, more preferably less than about 700 microns, more preferably less than about 300 microns. In some embodiments, the width of the open channel does not exceed about 250 microns. In certain embodiments, the open channel has a width of between about 10 and 250 microns, more preferably between about 50 and 200 microns. In other embodiments, the open channels have a width of at least 500 microns, more preferably at least 700 microns, most preferably at least 1500 microns

In certain embodiments, the open channel has a depth, measured as the distance between the bottom of the microfluidic channel and the plane of the surface of the cellulosic substrate, of less than about 1 mm, more preferably less than about 1000 microns, most preferably less than about 50 microns.

The open channels may be fabricated within the cellulosic or fibrous substrate in a linear configuration. The open channels may also be fabricated any other configuration required for device function, including a curved configuration, spiral configuration, angular configuration, or combinations thereof. The open channels may be fabricated such that the axis of fluid flow through the microfluidic channel lies within a single horizontal plane (i.e., a two dimensional configuration) or such that the axis of fluid flow through the microfluidic channel lies within multiple planes (i.e., a three dimensional configuration). In some embodiments, the open channel configured, in either a two dimensional or a three dimensional configuration, to form a micromixer which can function to mix one or more fluid streams within the open channel.

Open channel microfluidic devices may include one or more open channels. In some cases, two or more open channels may converge into a single open channel within the microfluidic device. Such a design may be incorporated into an open channel device, for example, to combine two or more liquids within a microfluidic device. Similarly, two or more open channels may diverge from a single open channel. Open channels may intersect in a variety of fashions as required for device performance, forming Y-shaped intersections, T-shaped intersections, and crosses. In addition, a plurality of open channels may converge in or diverge from a microfluidic chamber or a microwell.

Open channel microfluidic devices can also contain additional elements, such as fluid inlets, fluid outlets, and valves, to facilitate efficient handling of all fluids associated with the processing of a sample. Open channel microfluidic devices may also include one or more assay regions fluidly connected to a network of microfluidic channels. In cases where the microfluidic device is designed for an analytical application, the assay regions may be observed to identify and/or quantify one or more analytes in the liquid sample. In some cases, the one or more assay regions may include one or more assay reagents that serve as indicators for the presence of one or more analytes. The one or more assay regions may also include an electrode assembly that can be used to detect or quantify one or more analytes within a liquid sample.

In some embodiments, one or more of the microfluidic channels in the microfluidic device are closed channels. Closed channels are conduits that contain a porous hydrophilic substrate through which fluid flows by wicking bounded along one or more axes by a cellulosic substrate that has been covalently modified to make it hydrophobic, such that the covalently modified cellulosic substrate is substantially impermeable to the fluid flowing through the closed channel. Closed channels are characterized by the presence of a hydrophilic fibrous material in the path of fluid flow.

Closed channels may have varied dimensions depending on the applications for the microfluidic device. In certain embodiments, the open channel has a width of less than about 15 mm, more preferably less than about 3 mm, more preferably less than about 1 mm, most preferably less than about 500 microns. In certain embodiments, the closed channel has a height of less than about 1 mm, more preferably less than about 500 microns, most preferably less than about 200 microns.

Closed channel microfluidic devices can include one or more closed channels. In some cases, the closed channel microfluidic device contains one or more closed channels ranging in length from about 100 microns to about 10 cm. The closed channels may be linear in shape, or they may have any other configuration required for device function, including a curved configuration, spiral configuration, angular configuration, or combinations thereof. The closed channels may be fabricated such that the axis of fluid flow through the microfluidic channel lies within a single horizontal plane (i.e., a two dimensional configuration) or such that the axis of fluid flow through the microfluidic channel lies within multiple planes (i.e. a three dimensional configuration).

In some cases, two or more closed channels may converge into a single closed channel. Such a design may be incorporated into a closed channel device, for example, to combine two or more liquids within the microfluidic device. Similarly, two or more closed channels may diverge from a single closed channel. Closed channels may intersect in a variety of fashions, including Y-shaped intersections. T-shaped intersections, and crosses.

Closed channel microfluidic devices may also further include fluid inlets, assay regions, and combinations thereof.

Microfluidic devices can also include one or more microwells. Microwells are, for example, depressions formed within or between stacks of cellulosic substrate that have been covalently modified to increase their hydrophobicity that can hold a solid or liquid sample. In certain embodiments, the microfluidic device includes a plurality of microwells. In particular embodiments, the microfluidic device is a microwell plate that exclusively includes a plurality of microwells. In other cases, the microfluidic device includes one or more microwells in combination with one or more microfluidic channels.

Microfluidic devices can include any desired combination of open channels, closed channels, and microwells, as required for particular applications. In certain embodiments, all of the microfluidic channels in the microfluidic device are open channels. In other embodiments, all of the microfluidic channels in the microfluidic device are closed channels. In other embodiments, the microfluidic device includes both open channels and closed channels.

Microfluidic devices are fabricated, at least in part, from a cellulosic substrate that has been modified to increase its hydrophobicity. By fabricating microfluidic devices from covalently modified paper, as opposed to paper on which a hydrophobic material has been non-covalently absorbed, paper-based microfluidic devices with increasing functionality can be fabricated. For example, paper remains gas permeable after covalent modification. As a result, microfluidic devices formed from covalently modified paper can be used in a variety of applications that require gas permeability, including environmental monitoring, infochemistry, and biological culturing. Covalent modification can also be used to form hydrophobic gradients, stimuli-responsive (i.e., switchable) hydrophobic surfaces, and surfaces with tuned chemical properties, often in close abutment, so as to provide increased options for actuating fluid flow through the microfluidic device. In addition, the covalently modified cellulosic substrate can be flexed and folded without damaging the hydrophobicity of the substrate (and diminishing device performance).

Generally, the cellulosic substrate is flexible. In preferred embodiments, the cellulosic substrate can be bent through its thinnest dimension, rolled around a cylindrical rod with a diameter of at least two inches, and return to a flat configuration without damaging the integrity of the substrate, such that a microfluidic device fabricated from the cellulosic substrate can be treated in this fashion without damaging the integrity and/or functionality of the microfluidic device. For certain applications, it is preferable that the cellulosic substrate can be folded, creased, or otherwise mechanically shaped to impart structure and function to a microfluidic device formed from the cellulosic substrate.

Examples of suitable substrates include cellulose; derivatives of cellulose such as nitrocellulose or cellulose acetate; paper (e.g., card stock, craft paper, filter paper, chromatography paper); woven cellulosic materials; non-woven cellulosic materials; and thin films of wood that have been covalently modified to increase their hydrophobicity, as discussed below.

Preferably, the cellulosic substrate is paper. Paper is inexpensive, widely available, readily patterned, thin, flexible, lightweight, and can be disposed of with minimal environmental impact. Suitable papers include, but are not limited to, chromatography paper, card stock, filter paper, vellum paper, printing paper, wrapping paper, ledger paper, bank paper, bond paper, blotting paper, drawing paper, fish paper, tissue paper, paper towel, wax paper, and photography paper.

In certain embodiments, the cellulosic substrate is paper having a grammage, expressed in terms of grams per square meter (g/m²), of greater than 50, 60, 70, 75, 85, 100, 125, 150, 175, 200, 225, or 250.

Generally, the covalently modified cellulosic substrate is substantially impermeable to aqueous solutions. In preferred embodiments, the covalently modified cellulosic substrate has a contact angle with water, as measured using a goniometer, of more than 90° (i.e., it is hydrophobic). In particular embodiments, the covalently modified cellulosic substrate has a contact angle with water of more than about 95°, 100°, 105°, 110°, 115°, 120°, 125°, 130°, 135°, 140°, 145°, 150°, or 155°.

Microfluidic devices can be used to analyze one or more fluid samples. In certain embodiments, the microfluidic devices are used to detect a variety of analytes based of the design of the microfluidic device, including small molecules, proteins, lipids, polysaccharides, nucleic acids, prokaryotic cells, eukaryotic cells, particles, viruses, metal ions, and combinations thereof.

In some cases, the microfluidic devices are used to conduct point-of-care diagnostic testing. In these embodiments, the microfluidic devices can be designed to operate without any supporting equipment, such as personal computers, pumps, or external instrumentation. For example, the microfluidic device may contain one or more assay regions containing one or more assay reagents selected so as to provide a response that is visible to the naked eye. In other embodiments, the microfluidic device may be used in conjunction with external instrumentation.

Microfluidic devices can be used to analyze a variety of biological fluids, including blood, blood plasma, urine, sweat, VOC's from breath, cerebrospinal fluid, and vitreous fluid. Microfluidic devices can be used to analyze environmental samples, including water and soil samples. Microfluidic devices can also be used in quality control applications, including the analysis of food samples and pharmaceutical products.

Open channel microfluidic devices may be particularly well suited to processing samples containing suspended particles or large molecules, such as blood, environmental slurries, multi-phase suspensions, and other raw biological samples. In certain embodiments, an open channel microfluidic device is used to analyze a sample containing large macromolecules (such as DNA, RNA, and combinations thereof), suspended cells, viruses, particles, or combinations thereof which cannot be transported by wicking through a porous, hydrophilic substrate, such as paper.

In particular embodiments, the open channel microfluidic devices are used to culture, identify and/or quantify a pathogen, such as a bacteria, protest, or virus, in a biological sample. In another embodiment, the open channel microfluidic device is used to culture, identify and/or quantify cells in a biological solution.

### BRIEF DESCRIPTION OF THE DRAWINGS

FIG. 1 is a cross sectional view of an open channel in an open channel microfluidic device.

FIG. 2 is a cross sectional view of a closed channel in a closed channel microfluidic device.

FIG. 3 is a cross sectional diagram illustrating an exemplary method for forming an open microfluidic channel by embossing a cellulosic substrate.

FIG. 4 is a graph plotting the water contact angle (in degrees) measured on various paper substrates (from left to right: copy paper, VWR light duty wiper, Whatmann #1 filter paper, Whatman #1 chromatography paper, VWR Spec-Wipe wiper, and Whatmann 3 mm chromatography paper) silanized with (tridecafluoro-1,1,2,2-tetrahydrooctyl)trichlorosilane vapor.

FIG. 5 is a graph plotting the water contact angle (in degrees) measured on Whatmann 3 mm chromatography paper silanized with (tridecafluoro-1,1,2,2-tetrahydrooctyl)trichlorosilane vapor (left), and Whatmann 3 mm chromatography paper pre-treated with plasma, and subsequently silanized with (tridecafluoro-1,1,2,2-tetrahydrooctyl)trichlorosilane vapor.

FIGS. 6A-6C illustrate open channel microfluidic devices formed by embossing a cellulosic substrate material. FIG. 6A, left, shows a microfluidic device containing a ‘Y-shaped’ microfluidic channel with two fluid inlets. When aqueous solutions (water dyed different colors for purposes of illustration) are introduced at each of the fluid inlets, the streams of dyed water flowing through the microfluidic channel without mixing due to laminar flow (FIG. 6A, right). FIG. 6B, left, shows a microfluidic device containing a ‘T-shaped’ microfluidic channel with two fluid inlets. When aqueous solutions (water dyed different colors for purposes of illustration) are introduced at each of the fluid inlets, the streams of dyed water flowing through the microfluidic channel without mixing due to laminar flow (FIG. 6B, right). FIG. 6C, left, shows a microfluidic device containing a cross-shaped microfluidic channel with three fluid inlets. When aqueous solutions (water dyed different colors for purposes of illustration) are introduced at each of the fluid inlets, the streams of dyed water flowing through the microfluidic channel without mixing due to laminar flow (FIG. 6C, right).

FIG. 7 i-iii illustrates an exemplary strategy for forming open channels via etching. Open microfluidic channels were first designed using computer-assisted design software (Adobe® Illustrator® CS5, Adobe Systems Incorporated.). A digital craft cutter (Silhouette Cameo™) was used to etch the open channels into the surface of the cardstock paper substrate (FIG. 7, panel i). The cardstock was then covalently modified to increase its hydrophobicity, for example by reaction with 1H, 1H, 2H, 2H perfluorododecyl trichlorosilane (panel ii). After hydrophobic treatment of the cellulosic substrate, a cover and fluid inlets were attached to the device (panel iii).

FIG. 8 A-B schematic diagrams illustrating the layout of open channel microfluidic devices. Panel a illustrates a microfluidic device containing a ‘T-shaped’ microfluidic channel, two fluid inlets, and one fluid outlet. Panel b illustrates a microfluidic device containing a serpentine microfluidic channel (i.e., a micromixer), two fluid inlets, and one fluid outlet.

FIG. 9 A-D illustrates the performance of the microfluidic devices illustrated in FIG. 8. FIG. 9, panel a illustrates a microfluidic device containing a ‘T-shaped’ microfluidic channel, two fluid inlets, and one fluid outlet. The inset image illustrates a cross-section of the channel. The scale bar is 5 mm (100 μm in the inset image). As shown in FIG. 9, panel c, when aqueous solutions (water dyed different colors for purposes of illustration) are introduced at each of the fluid inlets, the streams of dyed water flowing through the microfluidic channel without mixing due to laminar flow. FIG. 9, panel b shows a microfluidic device includes two fluid inlets, a fluid outlet, and a serpentine segment of open channel. The inset image illustrates a cross-section of the channel. The scale bar is 5 mm (200 μm in the inset image). As illustrated in FIG. 9, panel d, when aqueous solutions (water dyed different colors for purposes of illustration) are introduced at each of the fluid inlets, the streams of dyed water flowing through the microfluidic channel mix when passing through the serpentine segment of open channel.

FIG. 10 A-B illustrates an exemplary strategy for integrating twist-type valves (a cross-sectional view of which is shown in panel a) into open channel microfluidic devices. Open channel devices were fabricated by engraving, as shown in FIG. 7, and valves formed from flangeless ferules and small machine screws were attached (panel b).

FIG. 11 A-D, panel a, illustrates the flow of the microfluidic device with both twist valves in the closed position. No fluid flows through the valves to reach the fluid outlet. FIG. 11, panel b, illustrates the flow of the microfluidic device with the left valve in the closed position and the right valve in the open position. Only the fluid injected through the right fluid flows reaches the fluid outlet. FIG. 11, panel c, illustrates the flow of the microfluidic device with the right valve in the closed position and the left valve in the open position. Only the fluid injected through the left fluid flows reaches the fluid outlet. As shown in FIG. 11, panel d, when both twist valves are in the open position, both fluids reach the fluid outlet.

FIG. 12 A-B schematically illustrates fold valves that can be incorporated into open channel microfluidic devices. FIG. 12, panel a shows a longitudinal cross-sectional view of an open channel microfluidic device, illustrating how a fold valve decreases fluid flow. When folded out of plane, the open channel is locally obstructed at the point of the fold, altering fluid flow through the channel. The layout of an exemplary device containing a fold valve is illustrated in FIG. 12, panel b. The open channel device was fabricated using the etching process, and includes two fluid inlets and a fluid outlet. As shown in FIG. 12, panel b, each open channel was designed to possess a ‘U-shaped’ segment extending from the device, such that the segment can be bisected by a line (the folding axis) perpendicular to the fluid flow path that does not intersect any other portion of the microfluidic segment. The microfluidic device could therefore be folded, such that the fold crosses the U-shaped segment of the open channel, forming a fold valve.

FIG. 13 A-D illustrates the performance of fold valves. FIG. 13 panel a, illustrates the flow of the microfluidic device with both fold valves in the closed position. No fluid flows through the valves to reach the fluid outlet. FIG. 13, panel b, illustrates the flow of the microfluidic device with the left fold valve in the closed position and the right fold valve in the open position. Only the fluid injected through the right fluid flows reaches the fluid outlet. FIG. 13, panel c, illustrates the flow of the microfluidic device with the right fold valve in the closed position and the left fold valve in the open position. Only the fluid injected through the left fluid flows reaches the fluid outlet. FIG. 13, panel d, illustrates fluid flow through the microfluidic device when both fold valves are in the open position. Fluids from both fluid inlets reach the fluid outlet. The scale bar in all panels is 5 mm.

FIG. 14 A-F demonstrates the ability of the dihedral angle of a fold valve to influence the flow rate through a microfluidic device. In panels a-e, the folding angle for the right channel fold valve was maintained at 90°. The left fold valve was then adjusted to different angles of folding: panel a) 90°, panel b) 60°, panel c) 45°, panel d) 30°, and panel e) 0°. FIG. 14, panel f, is a graph showing the flow rate (in mL/min) through the microfluidic device as a function of the dihedral folding angle of the fold valve (in degrees). The scale bar in all panels is 5 mm.

FIG. 15 A-D shows SEM images of transverse sections through the “fold” valves of FIG. 14, showing the constriction of the channel as a function of the folding angle at the valve at different angles of folding: a) 0°, b) 30°, c) 45°, and d) 90°. At folding angles of 30° and 45°, the channel height appears to be lower than before folding (0°). At 90°, the channel top and bottom appear to be in close contact (height of channel less than 3 μm).

FIG. 16 A-F is a schematic diagram illustrating the layout of a microfluidic device containing a porous water valve. FIG. 16, panel a illustrates that the device contains one ‘V-shaped’ channel, a straight line channel, a single fluid inlet, and two fluid outlets in which the two channels are separated 0.8 mm distance by a narrow region of hydrophobic porous substrate. FIG. 16, panel b, is an illustration showing pressure-dependent porous water valving between two microfluidic channels. Inset shows an SEM image of the network of pores within cardstock paper (scale bar 100 μm). FIG. 16, panel c, is an image of the device encased in tape. FIG. 16, panel d, shows that fluid follows the open path from the inlet to the outlet of the channel on the left. FIG. 16, panel e, shows that fluid follows from the inlet of the channel on the left to the outlet of the channel on the right using the shortest path. The scale bar in all panels is 5 mm.

FIG. 17 is a schematic diagram illustrating the layout of a microfluidic device containing two parallel open channels separated by a narrow region of substrate material (approximately 1 mm). A gas-liquid two-phase system (dissolved HCl(g) or NH₃(g)) is introduced into the first channel, and a sensor (an aqueous solution of an acid/base universal indicator) for the gaseous compound present in the first channel is introduced into the second channel. The gaseous compound diffuses through the porous substrate material, and reacts with the indicator in the second microfluidic channel.

FIG. 18 A-D illustrates the function of the device shown in FIG. 17. In FIG. 18, panel a, Channel A is left empty, while a stream of 0.5% universal pH indicator is introduced in channel B. In FIG. 18, panel b, a stream of 37% HCl (aq) is introduced in channel A, while channel B is left empty. In FIG. 18, panel c, streams of 37% HCl (aq) and 0.05% universal pH indicator are introduced in channels A and B, respectively. The transfer of HCl(g) between neighboring channels is imaged as the color change of the pH indicator from blue to yellow (from a pH of approximately 9 at the fluid inlet to a pH of approximately 5 at the fluid outlet). In FIG. 18, panel d, Channel A is left empty, while a stream of 0.5% universal pH indicator is introduced in channel B. In FIG. 18, panel e, a stream of 28% NH₄OH(aq) is introduced in channel A, while channel B is left empty. In FIG. 18, panel f, streams of 28% NH₄OH(aq) and 0.05% universal pH indicator are introduced in channels A and B, respectively. The transfer of NH₃ (g) between neighboring channels is imaged as the color change of the pH indicator from green to blue (from a pH of approximately 7 to a pH of approximately 10).

FIG. 19 shows photographs of the series of plugs of an aqueous solution of blue dye separated by air bubbles as they pass through the open channel in hydrophobic paper. Air is expelled through the paper membrane, as observed at a flow rate of 25 μL/s. Bubbles are not visible in the microfluidic channel as they rapidly diffuse through the walls of the device. The flow of the aqueous phase in the channel is uninterrupted.

FIG. 20 A-F is a demonstration of burning a device assembled from a layer of hydrophobic paper functionalized with C₁₀^{F} and tape (PET/EVA/LDPE).

FIG. 21 illustrates a closed channel microfluidic device fabricated using paper that has been covalently modified to increase its hydrophobicity. The scale bar is 5 mm.

FIG. 22 compares the performance of a closed channel microfluidic device fabricated using paper that has been covalently modified to increase its hydrophobicity (left) a closed channel microfluidic device fabricated using a plastic substrate material (right). The covalently modified paper serves as a barrier to confine fluids to flow through the closed channel without any leakage. As illustrated by the arrows in FIG. 22, in the case of similar closed channel microfluidic devices fabricated using a plastic substrate (office transparency film), fluid leaked from the closed channel into the gap between the plastic substrate and the transparent tape cover. The scale bar is both panels is 5 mm.

FIGS. 23A-23B illustrate a microwell plate formed from a cellulosic substrate that has been covalently modified to increase its hydrophobicity.

FIG. 23A shows a photograph of a 96-well paper plate. Each well in the 96-well paper plate has a diameter of 6.9 mm and a depth of ˜0.5 mm.

FIG. 23B is a set of paper well plates in which each well can hold up to 100 μL of an aqueous solution.

FIG. 24 is a schematic representation of a 3-dimensional open channel microfluidic device enabling two streams of fluid to cross one another multiple times without mixing. Gas inlets are connected to the back of the device, while fluid inlets and fluid outlets are present on the top of the device. Arrows indicate the direction of fluid flow through the device.

FIG. 25 is a schematic representation illustrating the layout of all of the substrate layers used to form the 3-dimensional device in FIG. 24. The device is formed from alternating layers of paper and double-sided tape, with a plastic transparency used as a cover. The layers were aligned and assembled together using the double sided tape. The device was then silanized to render the cellulosic substrate hydrophobic.

FIG. 26 illustrates the performance of the 3-dimensional microfluidic device illustrated in FIG. 24.

FIG. 26, panel a shows a photograph of the completed device. The two fluid inlets are located on the top left part of the device.

FIG. 26, panel b illustrates the performance of the device. Two aqueous pH indicator solutions (light grey—phenol red; black—bromophenol blue sodium salt) were introduced into the open channels via the fluid inlets. The device then distributed solutions both laterally and vertically from the fluid inlets to the fluid outlets. The droplets at the fluid outlets indicate that the device enables streams of fluid to cross one another multiple times without mixing.

FIG. 26 A-C, panel c illustrated the ability of the channels to independently react to gas-phase analytes. Selective areas of the bottom side of the two open channels (indicated by the dotted circles) were then connected to sources of fuming HCl(g) and NH₃(g) through polyethylene tubing. The gases diffused through the bottom paper layer into the channels containing the indicator solution, got dissolved into the solution, and changed the solution pH and color, producing a colorimetric response.

FIG. 27 A-B demonstrates open channel paper microfluidic devices for serial dilution and generation of droplets in microchannels.

FIG. 27, panel a, is an image of a device for serial dilution of two input fluid streams: the inlet flow is diluted by a factor of 2 at the each channel junctions of the ladder network.

FIG. 27, panel b, is a photograph of microfluidic dilution device filled with blue (0.05% Methylene Blue) and red (0.05% Congo Red) dyed water as the two input fluid streams mix.

FIG. 28 A-D, panel a, is a top view of a device incorporating a microfluidic T-junction composed of rectangular channels according to one or more embodiments. Representative micrographs of the system at different ratios of flow rates for the continuous and dispersed phase: FIG. 30, panel b, Qₒᵢₗ:Q_{water}=30, and L=˜40 μm, FIG. 28, panel c, Qₒᵢₗ: Q_{water}=8, and L=˜300 μm; FIG. 30, panel d, Qₒᵢₗ:Q_{water}=4, and L=˜600 μm.

FIG. 29 A-B illustrates an open channel microfluidic device fabricated by embossing a fibrous material. This device generates droplets during continuous fluid flow (here hexadecane dyed with Sudan Blue and water dyed with 0.05% Congo Red) along the main channel.

FIG. 30 A-F illustrates a microfluidic device according to one or more embodiments, capable of generating aqueous droplets of different length. For different rates of flow of continuous and dispersed fluid, Q_{water} and Q_{hexadecane}, the device can generate aqueous droplets of different lengths L (defined as the distance between the furthest downstream and upstream points along the interface of a fully detached immiscible plug). The coefficient L/w (where w is the width of the channel) can be modified by controlling the speed of the flow of hexadecane (Q_{hexadecane}) or water (Q_{water}) as shown in FIG. 28.

### DETAILED DESCRIPTION OF THE INVENTION

### I. Definitions

“Microfluidic Device,” as used herein, refers to a device that includes one or more microfluidic channels, one or more microfluidic chambers, one or more micro-wells, or combinations thereof designed to carry, store, mix, react, and/or analyze liquid samples, typically in volumes of less than one milliliter.

“Microfluidic channel,” as used herein, refers to a feature within a microfluidic device that forms a path, such as a conduit, through which one or more fluids can flow. Microfluidic channels have at least one cross-sectional dimension that is in the range from about 0.1 microns to about 500 microns.

“Open channel,” as used herein, refers to a microfluidic channel that includes a central void space through which a liquid sample flows, and a bottom and side walls formed from a cellulosic substrate that has been covalently modified to increase its hydrophobicity, such that the bottom and side walls of the open channel are substantially impermeable to the fluid flowing through the open channel.

“Closed channel,” as used herein, refers to a microfluidic channel that includes a porous hydrophilic substrate through which fluid flows by wicking, bounded at least in one plane by a cellulosic substrate that has been covalently modified to increase its hydrophobicity, such that the covalently modified cellulosic substrate is substantially impermeable to the fluid flowing through the closed channel.

“Substrate,” refers to a material that forms the structural components of a microfluidic device.

“Well,” as used herein, refers to a chamber, void, or depression formed within, or by stacking different cut patterns on a substrate that can hold a solid or liquid sample. “Microwell,” as used herein, refers to a well with a volume of less than one milliliter. Microwells which further contain a cover are referred to herein as microfluidic chambers.

“Micromixer.” as used herein, refers to a segment of an open microfluidic channel that is configured so as to mix one or more fluids flowing through the open microfluidic channel. Microfluidic mixers may be fabricated such that the axis of fluid flow through the micromixer lies within a single horizontal plane (i.e., a two dimensional configuration) or such that the axis of fluid flow through the microfluidic channel lies within multiple planes (i.e., a three dimensional configuration).

“Paper”, as used herein, refers to a web of cellulosic fibers that are formed, for example, from an aqueous suspension on a wire or screen, and are held together at least in part by hydrogen bonding. Papers can be manufactured by hand or by machine. Paper can be formed from a wide range of matted or felted webs of vegetable fiber, such as “tree paper” manufactured from wood pulp derived from trees, as well as “plant papers” or “vegetable papers” which include a wide variety of plant fibers (also known as “secondary fibers”), such as straw, bamboo, flax, and rice fibers. Paper can be formed from substantially all virgin pulp fibers, substantially all recycled pulp fibers, or both virgin and recycled pulp fibers. Paper may also include adhesives, fillers, dyes, and other additives.

“Flexible”, as used herein, refers to a pliable material which can be substantially bent through its thinnest dimension and return to a flat configuration without damaging the integrity of the material.

“Hydrophilic,” as used herein, refers to the property of having affinity for water. As a result, hydrophilic surfaces have a tendency to absorb water and/or be wetted by water. In certain embodiments, hydrophilic surfaces have a water contact angle, as measured using a goniometer, of less than 90°.

“Hydrophobic,” as used herein, refers to the property of having a lack of affinity for, or even repelling water. As a result, hydrophobic surfaces have a tendency not to be wetted by water. In certain embodiments, hydrophobic surfaces have a water contact angle, as measured using a goniometer, of greater than 90°.

### II. Microfluidic Devices

Microfluidic devices contain a network of microfluidic components, such as microfluidic channels, microfluidic chambers, microwells, or combinations thereof designed to carry, store, mix, react, and/or analyze liquid samples, typically in volumes of less than one milliliter. Microfluidic devices can also include other elements, such as valves, fluid inlets, and combinations thereof, so as to permit the efficient handling of all fluids associated with the processing of a sample.

A bench-top fabrication process is used to integrate the common elements of pressure-driven microfluidics (e.g. laminar flow, mixing, on/off valves, gradient and droplet generators) in a system that uses hydrophobic or omniphobic paper as a substrate. These easy-to-prototype, inexpensive, pressure-driven devices expand the repertoire of microfluidic manipulations and analyses that can be conducted using paper, and offer a useful new method for the fabrication of microfluidic devices. The use of a craft-cutting tool to fabricate pressure-driven microfluidic devices with feature sizes as small as 45 μm, using, as matrix for fabrication, hydrophobic or omniphobic paper prepared by chemical treatment of cellulose paper. These devices display low-Reynolds number fluid dynamics (e.g. laminar flow), make possible new types of simple valves and switches to control fluid flow, and exhibit high gas permeability. The particular design of the microfluidic device, including the number and type of microfluidic components present in the device and the arrangement of the microfluidic components within the device, will be dependent upon a number of factors including the intended application of the microfluidic device and the nature of the one or more fluid samples being processed. For example, in the case of microfluidic devices designed to screen a fluid sample for the presence of one or more analytes, the design of the microfluidic device may be influenced by the complexity of the sample to be analyzed, including the suspected number of analytes in the sample, the nature of the sample, and the nature of the analytes. In addition, device design may be influenced by its intended use. For example, devices designed for point-of-care diagnostic applications, particularly in developing countries, may be designed to operate independent of any external instrumentation e.g. gravity flow).

Microfluidic devices include at least one fluid flow path, formed by one or more microfluidic components through which fluid flows during sample processing. In some cases, a single microfluidic device can include multiple fluid flow paths. In these instances, the plurality of fluid flow paths may be positioned in any convenient arrangement within the device, and may or may not intersect, depending on the device design.

In some cases, the microfluidic device contains one or more microfluidic channels ranging in length from about 100 microns to about 3 cm. The microfluidic channels may be linear in shape, or they may have any other configuration required for device function, including a curved configuration, spiral configuration, angular configuration, or combinations thereof.

As discussed above, microfluidic devices may include may include multiple microfluidic channels which intersect at various points. In some cases, two or more microfluidic channels may converge into a single microfluidic channel. Such a design may be incorporated into a microfluidic device, for example, to combine two or more liquids within a microfluidic device. Similarly, two or more microfluidic channels may diverge from a single microfluidic channel, so as to, for example, permit a sample to be separated into multiple flow paths that can be independently analyzed. Microfluidic channels may intersect and diverge in a variety of fashions as required for device performance, including Y-shaped intersections, T-shaped intersections, and crosses. In addition, a plurality of microfluidic channels may converge in or diverge from a microfluidic chamber or a microwell.

In some embodiments, one or more of the microfluidic channels in the microfluidic device are open channels. Open channels are conduits that contain a central void space through which fluid flows, and a bottom and side walls formed from a cellulosic substrate that has been covalently modified to increase its hydrophobicity, such that the bottom and side walls of the open channel are substantially impermeable to the fluid flowing through the open channel.

In some embodiments, one or more of the microfluidic channels in the microfluidic device are closed channels. Closed channels are conduits that contain a porous hydrophilic substrate through which fluid flows by wicking bounded by a cellulosic substrate that has been covalently modified to increase its hydrophobicity, such that the covalently modified cellulosic substrate is substantially impermeable to the fluid flowing through the closed channel.

In certain embodiments, all of the microfluidic channels in the microfluidic device are open channels. In other embodiments, all of the microfluidic channels in the microfluidic device are closed channels. In other embodiments, the microfluidic device includes both open channels and closed channels.

Microfluidic devices can also include one or more microwells. Microwells are, for example, depressions formed within cellulosic substrate that has been covalently modified to increase its hydrophobicity that can hold a solid or liquid sample. In certain embodiments, the microfluidic device includes a plurality of microwells. In particular embodiments, the microfluidic device is a microwell plate that exclusively includes a plurality of microwells. In other cases, the microfluidic device includes one or more microwells in combination with one or more microfluidic channels.

Microfluidic devices can include any desired combination of open channels, closed channels, and microwells, as required for particular applications.

In certain embodiments, microfluidic devices include one or more assay regions fluidly connected to a network of microfluidic channels. In cases where the microfluidic device is designed for an analytical application, the assay regions may be observed to identify and/or quantify one or more analytes in the liquid sample. In some cases, the one or more assay regions may include one or more assay reagents that serve as indicators for the presence of one or more analytes. The one or more assay regions may also include an electrode assembly that can be used to detect or quantify one or more analytes within a liquid sample.

The microfluidic device can also contain additional elements, such as fluid inlets, fluid outlets, and valves, to facilitate efficient handling of all fluids associated with the processing of a sample.

The overall shape of the microfluidic device may be varied. In preferred embodiments, the network of microfluidic components that make up the microfluidic device, as well as any other elements, e.g., valves, fluid inlets, etc., are present in an essentially planar substrate, such as a card-shaped or disk-shaped substrate

In some embodiments, the microfluidic device has a total thickness of between about 40 microns and about 2 cm, more preferably between 40 and 1 mm, most preferably between 70 and 500 microns. In certain embodiments, the microfluidic device has a total thickness of between 100 microns and 1 cm.

In some cases, the microfluidic device is formed exclusively from biodegradable materials. In other embodiments, the microfluidic device is fabricated entirely from materials that can be burned without producing harmful byproducts.

A. Open Channel Microfluidic Devices

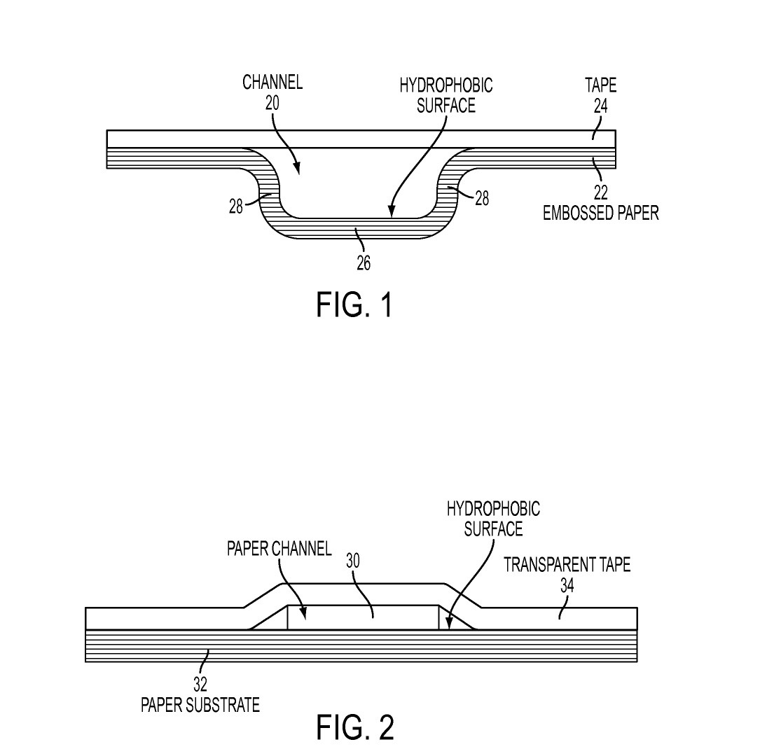

Open channel microfluidic devices include one or more open channels. As shown in FIG. 1, an open channel (20) includes a bottom (26) and side walls (28). The bottom and side walls are formed from a hydrophobic cellulosic substrate (22) that has been covalently modified to increase its hydrophobicity, such that the bottom and side walls of the open channel are substantially impermeable to the fluid flowing through the open channel. Typically, the open channels further include a cover (24).

Generally, as shown in FIG. 1, the open channel has a cross-section that is substantially U-shaped. However, the open channel can be fabricated to have a variety of cross-sectional shapes, including square, rectangular, triangular (i.e., v-shaped), hemispherical, and ovular.

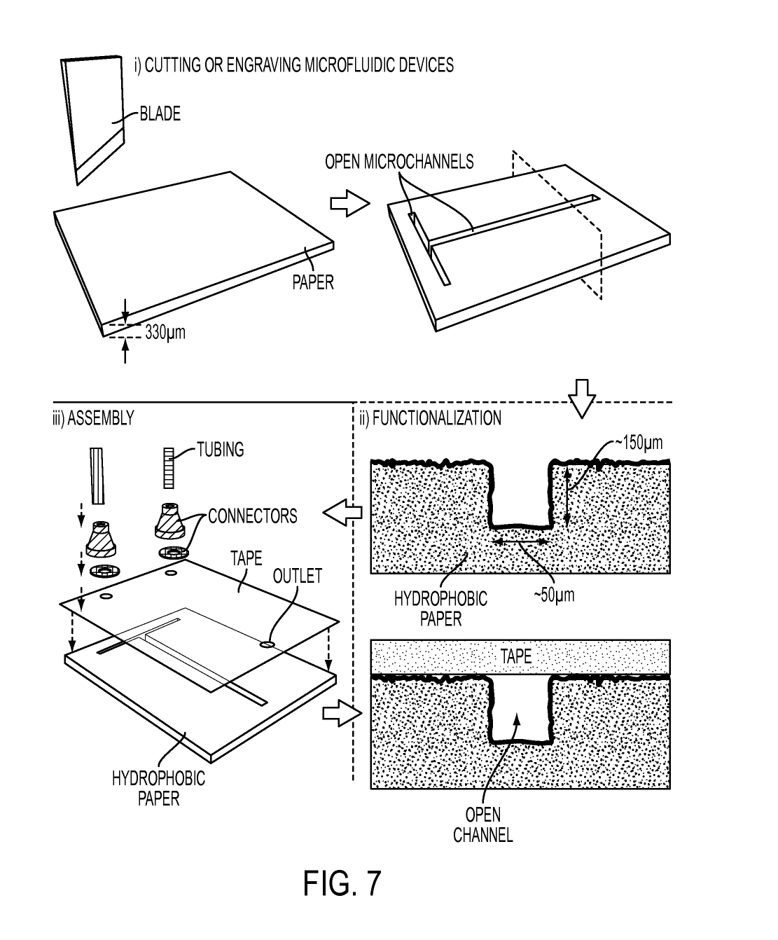

In other embodiments, as shown in FIG. 7, the channel can be etched, engraved or carved into the cellulosic substrate. The thickness of the cellulosic substrate is greater than the channel depth. For example, in FIG. 7, panel i, the thickness of the substrate is about 330 μm and the depth of the channel is 150 μm. The microfluidic device also includes cover.

Open channels may have varied dimensions depending on the applications for the microfluidic device. In certain embodiments, the open channel has a width, measured as the distance between the two side walls of the microfluidic channel at the surface of the cellulosic substrate, of less than about preferably less than about 1 cm preferably less than about 500 microns, more preferably less than about 300 microns.

In some embodiments, the open channels are dimensioned or configured such that fluid is capable of flowing through the open channel by capillary flow (i.e., the micro-channel is of capillary dimensions). By capillary dimensions, it is meant that the width of the open channel does not exceed about 250 microns. In certain embodiments, the open channel has a width of between about 10 and 250 microns, more preferably between about 50 and 700 microns.

In certain embodiments, the open channel has a depth, measured as the distance between the bottom of the microfluidic channel and the plane of the surface of the cellulosic substrate, of less than about 1 mm, more preferably less than about 500 microns, most preferably less than about 200 microns.

Open channel microfluidic devices can include one or more open channels. In some cases, the open channel microfluidic device contains one or more open channels ranging in length from about 100 microns to about 10 cm. The open channels may be linear in shape, or they may have any other configuration required for device function, including a curved configuration, spiral configuration, angular configuration, or combinations thereof. The open channels may be fabricated such that the axis of fluid flow through the microfluidic channel lies within a single horizontal plane (i.e., a two dimensional configuration) or such that the axis of fluid flow through the microfluidic channel lies within multiple planes (i.e., a three dimensional configuration).

In some cases, two or more open channels may converge into a single open channel. Such a design may be incorporated into an open channel device, for example, to combine two or more liquids within a microfluidic device. Similarly, two or more open channels may diverge from a single open channel. Open channels may intersect in a variety of fashions as required for device performance, forming Y-shaped intersections, T-shaped intersections, and crosses. In addition, a plurality of open channels may converge in or diverge from a microfluidic chamber or a microwell.

In open channels, parallel liquid streams can exhibit either laminar flow, where the fluid streams flow parallel along each other within a channel, and mixing occurs only by diffusion, or turbulent flow, where turbulence mixes the two fluid streams in the open channel. The Reynolds Number (Re), defined by equation 1 below, indicates whether flow is laminar or turbulent:

Re=νlρlμ (1)

where ν is the velocity of the fluid in the channel (m/s), l is the cross-sectional dimension of the channel (m), ρ is the density of the fluid (for water, 1000 kg/m³), and μ is the viscosity of the fluid (for water, 10⁻³ kg/(m·s)). Both ρ and μ are characteristics of the fluids introduced into the microfluidic device; however, ν and l can be varied by, for example, device design. Typically, in the case of open channel devices containing small microfluidic channels (less than about 250 microns) and operating at a low flow rate (less than about 1 cm/s), Re generally correlates with laminar flow behavior.

In some embodiments, the open channel configured to form a micromixer. Micromixers can be used to mix one or more fluid streams within the open channel. An open channel can contain one or more micromixers along the fluid flow path, as required for a particular application. A wide variety of micromixers are known in the art. See, for example, Nguyen and Wu, J. Micromechan. Microeng., 15:R1-R16 (2005) and Lee, et al Int. J. Mot Sci. 12: 3263-3287 (2011). In certain embodiments, the open channel is configured to form a zigzag or serpentine micromixer (Liu, et al. J. Microelectomech. Systems, 9:190-198(2000)). In these embodiments, the open channel repeatedly changes direction within a short segment, inducing sufficient turbulence to mix the fluids flowing in the open channel. Open channels may also be configured to form a Tesla-type micromixer or a shear superposition micromixer. Open channels may also be designed to incorporate a chaotic advection mixer, such as a herringbone mixer, which can be, for example, embossed into the bottom of the open channel.

Open channel microfluidic devices can also contain additional elements, such as fluid inlets, fluid outlets, and valves, to facilitate efficient handling of all fluids associated with the processing of a sample.

1. Cellulosic Substrates

Open channel microfluidic devices are formed from a cellulosic substrate that has been covalently modified to increase its hydrophobicity. The cellulosic substrate can be covalently modified using any suitable methodology, as discussed below.

Generally, the cellulosic substrate is flexible. In preferred embodiments, the cellulosic substrate can be bent through its thinnest dimension, rolled around a cylindrical rod with a diameter of at least two inches, and return to a flat configuration without damaging the integrity of the substrate, such that a microfluidic device fabricated from the cellulosic substrate can be treated in this fashion without damaging the integrity and/or functionality of the microfluidic device. For certain applications, it is preferable that the cellulosic substrate can be folded, creased, or otherwise mechanically shaped to impart structure and function to a microfluidic device formed from the cellulosic substrate.

Examples of suitable substrates include cellulose; derivatives of cellulose such as nitrocellulose or cellulose acetate; paper (e.g., craft paper, card stock, filter paper, chromatography paper); woven cellulosic materials; non-woven cellulosic materials; and thin films of wood that have been covalently modified to increase their hydrophobicity, as discussed below.

Preferably, the cellulosic substrate is paper. Paper is inexpensive, widely available, readily patterned, thin, lightweight, and can be disposed of with minimal environmental impact. Furthermore, a variety of grades of paper are available, permitting the selection of a paper substrate with the weight (i.e., grammage), thickness and/or rigidity and surface characteristics (i.e., chemical reactivity, hydrophobicity, and/or roughness), desired for the fabrication of a particular microfluidic device. Suitable papers include, but are not limited to, chromatography paper, card stock, filter paper, vellum paper, printing paper, wrapping paper, ledger paper, bank paper, bond paper, blotting paper, drawing paper, fish paper, tissue paper, paper towel, wax paper, and photography paper.

Exemplary paper includes cardstock paper, which is particularly suitable as the cellulosic material is lightweight and flexible, sufficiently smooth to create a tight seal with tape and inexpensive; it is also thick enough (300 μm) to retain mechanical stability while accommodating the channel depths generated using etching or carving (see below). Thinner, more flexible paper can be used when channels are introduced into the paper by embossing, if desired.

In certain embodiments, the cellulosic substrate is paper having a grammage, expressed in terms of grams per square meter (g/m²), of greater than 50, 60, 70, 75, 85, 100, 125, 150, 175, 200, 225, or 250.

Generally, the covalently modified cellulosic substrate is substantially impermeable to aqueous solutions. In preferred embodiments, the covalently modified cellulosic substrate has a contact angle with water, as measured using a goniometer, of more than 90° (i.e., it is hydrophobic). In particular embodiments, the covalently modified cellulosic substrate has a contact angle with water of more than about 95°, 100°, 105°, 110°, 115°, 120°, 125°, 130°, 135°, 140°, 145°, 150°, or 155°.

In certain embodiments, the covalently modified cellulosic substrate has a high gas (oxygen) permeability. In preferred embodiments, the covalently modified cellulosic substrate has a gas (oxygen) permeability of greater than about 5,000 Barrer, more preferably greater than about 10,000 Barrer, more preferably greater than about 25,000 Barrer, more preferably greater than about 50,000 Barrer. In certain embodiments, the covalently modified cellulosic substrate has a gas (oxygen) permeability of greater than about 75,000 Barrer.

If desired, the cellulosic substrate may be affixed to or secured within a polymer, metal, glass, wood, or paper support structure to facilitate handling and use of the microfluidic device.

2. Covers

The open channel microfluidic devices further include a cover that seals the top of the open microfluidic channel. The cover may be formed from paper, glass, polymer, fabric, metal, and combinations thereof, with the proviso that the material is impermeable to the liquid flowing through the open channel or does not wet with the liquid flowing through the channel. Generally, the cover is a thin film or sheet, such as a polymer thin film.

Examples of suitable covers include, for example, thin films or sheets of polyethylene, polypropylene, such as high density polypropylene, polytetrafluoroethylene (PTFE), e.g., TEFLON®, polymethylmethacrylate, polycarbonate, polyethylene terephthalate, polystyrene or styrene copolymers, polyurethanes, polyesters, polycarbonates, polyureas, polyamides, polyethyleneamines, polyarylene sulfides, polysiloxanes, polydimethylsiloxanes, polyimides, polyacetates, and polyether ether ketone (PEEK).

In certain embodiments, the cover is an adhesive sheet or tape that is adhered to the surface of the cellulosic substrate. Any suitable adhesive tape can be used. Preferably, the backing of the tape is impermeable to the liquid flowing through the open channel. Examples of suitable adhesive tapes include Scotch Tape 600, Scotch Tape 610, Scotch Tape 810, and Scotch Tape 811 (available from 3M, Minneapolis Minn.).

In other embodiments, the cover is formed from a cellulosic substrate that has been covalently modified to increase its hydrophobicity. In these cases, the cellulosic substrate can be affixed to the surface of the microfluidic device using an adhesive.

3. Fluid Inlets

Open channel microfluidic devices typically include one or more fluid inlets. Fluid inlets are ports, openings, or reservoirs which provide a volume of fluid that flows through the microfluidic device during operation. See, e.g., FIG. 7, panel iii. In certain cases, the open channel microfluidic device includes a single fluid inlet for the introduction of a liquid sample to be processed. In other cases, the open channel microfluidic device includes multiple fluid inlets. Generally, one or more fluid inlets are fluidly connected to each microfluidic network in the open channel microfluidic device.

The number of fluid inlets in the device may be governed by the intended function of the device. For example, in the case of microfluidic devices used to analyze a single sample, the device may contain at least one fluid inlet for the sample to be analyzed. The device may further include one or more fluid inlets to supply solvent to dilute the sample to be analyzed, one or more fluid inlets to supply reagents for use in the analysis of the sample, one or more fluid inlets to provide a solution to be used as a control during sample analysis, and combinations thereof.

Typically fluid flow through an open channel microfluidic devices is induced by the application of pressure. In many cases, the pressure is applied to the fluid inlets to induce fluid flow. In the case of a microfluidic device containing multiple fluid inlets, pressure can be applied to one or more of the fluid inlets independently, such that the flow rate may be the same or different through each microfluidic network within the microfluidic device.

Pressure may be applied to induce fluid flow by any suitable means, including a syringe, a pump, such as a syringe pump, gravity, or combinations thereof. By varying the pressure applied to the fluid inlets, the flow rate through the microfluidic device can be varied. In some embodiments, pressure is applied to the fluid inlets of the microfluidic device, such that the flow rate within the microfluidic device ranges from about 0.01 μL/min to about 1 mL/min, more preferably from about 0.1 μL/min to about 500 μL/min. In certain cases, the flow rate ranges between about 10 μL/min and about 30 μL/min.

Suitable fluid inlets can be fabricated from flangeless ferrules (such as P-200NX ferrules available from Upchurch Scientific, Oak Harbor, Wash.) and standard tubing, such as polyethylene tubing. The ferrules are positioned over one or more microfluidic features, such that the interior of the ferrules is fluidly connected to the microfluidic network. The ferrules can be affixed to the surface of the microfluidic device using any suitable means, such as double-sided adhesive tape or a conventional adhesive. Tubing, such as polyethylene tubing, can be connected to the microfluidic network via the ferrule to form a fluid inlet.

Fluid inlets can also be attached using other suitable methods, such as melting the end of polymer tubing forming the fluid inlet so as to fuse with the cover, melt into the cellulosic substrate, or combinations thereof.

If desired, fluid inlets may be threaded to receive, for example, a syringe.

4. Valves

Open channel microfluidic devices can also include one or more valves. Valves are features within a microfluidic device that control the flow of fluids through the microfluidic device. One or more valves can be used to start and/or stop the flow of a fluid through one or more microfluidic features within a microfluidic device. Valves can also be used to increase or decrease the flow rate of one or more fluids through a microfluidic channel.

Any suitable valve may be incorporated into the open channel microfluidic devices described herein. In certain embodiments, the valve is a threaded actuator functionally integrated on or within the cellulosic substrate in proximity to a microfluidic channel, such that rotation of the actuator compresses or decompresses the microfluidic channel, and controls fluid flow through the microfluidic channel. Valves of this type, termed “twist valves,” are known in the art. See, for example, U.S. Patent Application Publication No. US 2010/0116343 to Weibel, et al.

Suitable twist valves can be fabricated from flangeless ferrules (such as P-200NX ferrules available from Upchurch Scientific, Oak Harbor, Wash.) and machine screws. The ferrules can be affixed to the surface of the microfluidic device using any suitable means, such as double-sided adhesive tape or a conventional adhesive. Typically, the twist valve is positioned above or below a microfluidic channel, such that the machine screw, when rotated within the ferrule, transitions between a first point where the machine screw does not block or compress the microfluidic channel, and a second point where the machine screw blocks or compresses the microfluidic channel. If required, the bottom surface of the machine screws can be coated with a this surface of an inert polymer, such as polydimethylsiloxane (PDMS), that forms a cushion which can seal the microfluidic channel to impede fluid flow without damaging the cellulosic substrate. By rotating the machine screw within the ferrule, the fluid flow rate through the microfluidic channel can be controlled.

In the case of open channel microfluidic devices formed from a flexible cellulosic substrate, such as paper, the flow of fluid through a microfluidic channel can also be controlled by mechanically manipulating the cellulosic substrate. For example, the paper can be folded in a fashion so as to traverse one or more open channels within the microfluidic device. By creasing or folding the cellulosic substrate, the flow rate through the microfluidic channel can be altered. In certain embodiments, the paper is folded in a fashion traversing one or more open channels within a microfluidic device to stop the flow of fluid through the microfluidic channel, and unfolded to start the flow of fluid through the microfluidic channel.

Valves can also be formed in an open channel microfluidic device by depositing one or more stimuli responsive materials within an open channel. In these cases, the stimuli responsive material reacts during operation of the microfluidic device, altering the flow of one or more fluids through the microfluidic device. Examples of suitable stimuli responsive materials include hydrogels, polymers (e.g., swellable polymers), such as, for example, polyacrylamide, expandable materials commonly referred to as superabsorbent polymers (SAPs), and/or other available materials.

The stimuli responsive materials may be selected to respond to a variety of stimuli including pH, temperature, ionic strength of a solution, external radiation (e.g., UV light), or any combination thereof. For example, a valve can be formed in an open channel by depositing a pH-responsive hydrogel within the microfluidic channel. By swelling or collapsing in response to a change in pH, the hydrogel may regulate the flow of fluid through an open channel in a pH-dependent manner.

Valves can also be fabricated by covalently modifying a region of the cellulosic substrate to form a stimuli-responsive (i.e., switchable) hydrophobic coating. In these embodiments, the substrate is modified with a reagent to increase its hydrophobicity which is responsive to external stimuli, such that one or more external stimuli can induce a change in substrate hydrophobicity/hydrophilicity. For example, the cellulosic substrate may be modified by attaching a hydrophobic molecule via a labile linkage that is cleaved in response to an external stimulus, such as a pH, temperature, ionic strength of a solution, external radiation (e.g., UV light), or any combination thereof. In these cases, an external stimulus, such as a change in the pH of a fluid flowing through a microfluidic channel, can trigger a decrease in hydrophobicity, altering fluid flow.

Open channel microfluidic devices may also contain one or more pressure dependent valves, such as porous water valves. A pressure dependent porous water valve can be formed by a region of paper that has been covalently modified to increase its hydrophobicity. Due to the low surface energy of the covalently modified paper surface, liquid water does not spontaneously enter the pores of the hydrophobic paper. Work must be done to force the water through the hydrophobic pores by applying sufficient pressure to overcome the surface free energy. Below this threshold pressure, the porous valve can be considered to be off. The valve is “turned on” when the pressure threshold is reached and water is forced to flow through the pores of paper.

The pressure (P) that must be applied to force water into pores of radius (r) is given by the Young and Laplace Equation:

P=2γ Cos θ/r (2)

where γ_{water} is the surface energy of water, θ is the contact angle of water with the surface, and r is the radius of the pore. For example, the minimum pressure required for water flow through the pores of cardstock paper functionalized with 1H, 1H, 2H, 2H perfluorodecyl trichlorosilane is approximately 300 Torr, or 40 kPa.

In another system, in which θ_{S}^{H20} ˜137°, γ=0.072 mN/m, and R˜2.6 μm, Eq. 1 predicts that a difference in pressure of 26 kPa is required to overcome the surface free energy. This value is—perhaps coincidentally—that at which the escape of water from the channel into the hydrophobic pores of the surrounding paper matrix is observed.

After water enters the pores, additional pressure is needed to overcome the resistance of the viscous liquid in order to push more water into the paper. The pressure difference required to move water through pores in paper across a distance L is given by the Darcy equation, where Q is the rate of the flow through the porous medium (m³/s), k is the permeability of the medium (m²), A is the cross sectional area to flow (m²), ΔP_{μ} is the pressure drop (Pa), and μ is the viscosity of the liquid (Pa·s):

$$Δ {P}_{μ} = \frac{μ LQ}{k A} \qquad ( 2 )$$

where τ is the time required for water to flow through pores in paper across a distance L.

The pressure needed to drive water into and across the porous medium of length L is the sum of the pressures as expressed in equations 1 and 2:

$$Δ {P}_{total} = - \frac{2 γ cos {θ}_{s}^{H 2 O}}{R} + \frac{μ LQ}{kA} \qquad ( 3 )$$

The porous valve is “closed” below this threshold pressure. When the pressure exceeds the threshold value, the valve “opens” and water is forced through the pores of the paper.

An exemplary porous water valve can be formed from two ‘V-shaped’ channels separated by a narrow region of hydrophobic porous substrate. Only when the pressure reaches a sufficient threshold, as discussed above, will the solution pass through the hydrophobic porous substrate separating the two channels.

Valves can also be formed by covalently modifying a region of the cellulosic substrate in a gradient fashion to increase its hydrophobicity. In these cases, the cellulosic substrate can be covalently modified, for example, with reagents of increasing hydrophobicity along a fluid flow path. As the pressure increases, fluid will be permitted to flow further along the gradient.

5. Fluid Outlets

Open channel microfluidic devices may optionally include one or more fluid outlets. Fluid outlets are ports, openings, or reservoirs through which or into which one or more fluids flows after passage through the microfluidic network.

In some embodiments, the fluid outlet is a fluid sink formed in the cellulosic substrate, such as a large microfluidic chamber or microfluidic well, into which fluid flows following passage through the microfluidic network.

The fluid outlet can also be a port which fluidly connects the microfluidic network to an external device. For example, a microfluidic device may contain one or more fluid outlets that connect the microfluidic network to one or more external instruments, such as a mass spectrometer, fluorometer, UV-Vis spectrometer, IR spectrometer, gas chromatograph, gel permeation chromatograph, DNA sequencer, Coulter counter, or combinations thereof, that can be used to analyze the fluid flowing from the microfluidic network.

Suitable fluid inlets can be fabricated from flangeless ferrules (such as P-200NX ferrules available from Upchurch Scientific, Oak Harbor, Wash.) and standard tubing, such as polyethylene tubing. The ferrules are positioned over one or more microfluidic features, such that the interior of the ferrules is fluidly connected to the microfluidic network. The ferrules can be affixed to the surface of the microfluidic device using any suitable means, such as double-sided adhesive tape or a conventional adhesive. Tubing, such as polyethylene tubing, can be connected to the microfluidic network via the ferrule to form a fluid outlet.

Fluid outlets can also be attached using other suitable methods, such as melting the end of polymer tubing forming the fluid inlet so as to fuse with the cover, melt into the cellulosic substrate, or combinations thereof.

In other embodiments, the fluid outlets are holes present at the end of the microfluidic channel (e.g., holes punched through the cover of the open channel).

6. Gas Inlets

In certain embodiments, the microfluidic device includes one or more gas inlets. Gas inlets are ports, openings, or reservoirs through which or into which one or more gases flow. These inlets are located in proximity to the microfluidic channel, such that gas passing into the inlet can readily diffuse through the cellulosic substrate, and reach the fluid within the microfluidic channel.

7. Assay Regions

Open channel microfluidic devices may include one or more assay regions fluidly connected to a network of microfluidic channels. In cases where the microfluidic device is designed for an analytical application, the assay regions may be observed to identify and/or quantify one or more analytes in the liquid sample. In some cases, the one or more assay regions may include one or more assay reagents that serve as indicators for the presence of one or more analytes. The one or more assay regions may also include an electrode assembly that can be used to detect or quantify one or more analytes within a liquid sample.

In some embodiments, the one or more assay regions are microwells, such as those described below. In embodiments where the assay regions are microwells, the microwells will typically have one or more microfluidic channels configured to allow fluid to flow into the microwell.

In other embodiments, the one or more assay regions are formed from a porous hydrophilic substrate fluidly connected to the microfluidic network, and laterally bounded by an impermeable hydrophobic material. The porous hydrophilic substrate may be any porous, hydrophilic substrate that wicks fluids by capillary action. Examples of suitable porous hydrophilic substrates include paper, cellulose derivatives, such as nitrocellulose or cellulose acetate, non-woven fabrics, woven fabrics, and hydrophilic, porous polymer films. In certain embodiments, the porous hydrophilic substrate is paper, such as chromatography paper, card stock, filter paper, vellum paper, printing paper, wrapping paper, ledger paper, bank paper, bond paper, blotting paper, drawing paper, fish paper, tissue paper, paper towel, wax paper, or photography paper.

In other embodiments, the assay region is a microfluidic channel or microwell containing an electrode assembly. One or more electrodes can be integrated within the microfluidic channel or microwell to facilitate electrochemical analysis. In these embodiments, the one or more electrodes may be fabricated from suitable conductive materials, including carbon ink, silver ink, Ag/AgCl ink, copper, nickel, tin, gold, platinum, and combinations thereof.

a. Assay Reagents

Assay regions may be treated with one or more assay reagents that serve as indicators for the presence of one or more analytes. In certain embodiments, the assay reagents facilitate the detection and/or quantification of one or more analytes, such as small molecules, proteins, lipids, polysaccharides, nucleic acids, prokaryotic cells, eukaryotic cells, particles, viruses, fungi, metal ions, or combinations thereof.

In certain cases, the microfluidic devices may be intended to detect and/or quantify one or more analytes without the use of complicated and expensive instrumentation. In these instances, the one or more assay reagents may be selected so as to provide a response that is visible to the naked eye. For example, the assay reagent can be an indicator that exhibits colorimetric and/or fluorometric response in the presence of the analyte of interest. Indicators may include molecules that become colored in the presence of the analyte, change color in the presence of the analyte, or emit fluorescence, phosphorescence, or luminescence in the presence of the analyte. In other embodiments, the one or more assay reagents are selected to facilitate radiological, magnetic, optical, and/or electrical measurements used to identify and/or quantify one or more analytes in a liquid sample.

Depending on the target analyte, a wide variety of assay reagents may be incorporated into the assay regions. Examples of suitable assay reagents include antibodies, nucleic acids, aptamers, molecularly-imprinted polymers, molecular beacons, chemical receptors, proteins, peptides, inorganic compounds, nanoparticles, microparticles, and organic small molecules. The assay reagents can be applied to an assay region by a variety of suitable methods. For example, or more assay reagents may be deposited and/or immobilized within an assay region by applying a solution containing the one or more assay reagents, and allowing the solvent to evaporate.

In some instances, one or more assay reagents are non-covalently immobilized by physical absorption in or on the assay region. The one or more assay reagents are covalently linked to the cellulosic substrate or porous hydrophilic substrate forming the assay region. Assay reagents can be covalently immobilized using a variety of chemical techniques known in the art, including similar chemistry to that used to immobilize molecules on beads or glass slides, or to link molecules to carbohydrates. In particular embodiments, one or more assay reagents are covalently coupled to a cellulosic substrate forming the assay region via an ester, amide, imine, ether, carbon-carbon, carbon-nitrogen, carbon-oxygen, or oxygen-nitrogen bond.

By way of exemplification, to facilitate the detection and/or quantification of a protein in a liquid sample, an assay region can be derivatized with an assay reagent, such as a small molecule, that selectively binds to or interacts with the protein. Similarly, to detect and/or quantify a specific antibody in a liquid sample, an assay region of the can be derivatized with an assay reagent that selectively binds to or interact with that antibody, such as an antigens.

In some embodiments, the interaction of an analyte of interest with one or more assay reagents may not result in a visible color change. If desired for a particular application, the assay region can be additionally treated with a stain or a labeled protein, antibody, nucleic acid, molecular beacon, or other reagent that binds to the target analyte after it binds to the reagent in the assay region, and produces a visible color change. This can be done, for example, subsequently introducing a stain or labeled reagent to the assay region after the assay region has been contacted with sample to be analyzed. In certain embodiments, a stain or labeled reagent is introduced into the one or more assay regions via a microfluidic channel after the assay region has been contacted with sample to be analyzed.

B. Closed Channel Microfluidic Devices

Closed channel microfluidic devices include one or more closed channels.

As shown in FIG. 2, a closed channel is a conduit formed by a porous hydrophilic substrate (30) through which fluid flows by wicking, bounded by a cellulosic substrate that has been covalently modified to increase its hydrophobicity (32) and a cover (34), such that the porous hydrophilic substrate is bounded by a hydrophilic material along all axes other than the axis along which fluid flows.

Generally, as shown in FIG. 2, the closed channel has a cross-section that is substantially rectangular. In these embodiments, the closed channel can be described as having a bottom, two side walls, and a top. However, the closed channel can be fabricated to have a variety of cross-sectional shapes, including a square, triangle, or ovular cross-section.

In some embodiments, at least one face of the closed channel is bounded by a cellulosic substrate that has been covalently modified to increase its hydrophobicity. In certain embodiments, at least three faces of the closed channel are bounded by a cellulosic substrate that has been covalently modified to increase its hydrophobicity. In one embodiment, the closed channel is bounded along all axes other than the axis along which fluid flows by a cellulosic substrate that has been covalently modified to increase its hydrophobicity.

In some cases, the bottom of the closed channel is formed by a cellulosic substrate that has been covalently modified to increase its hydrophobicity. In certain cases, the side walls are formed by a cellulosic substrate modified to increase its hydrophobicity. In some cases, the top of the closed channel is formed by a cellulosic substrate that has been covalently modified to increase its hydrophobicity.

In certain embodiments, the porous hydrophilic material which forms the closed channel and the cellulosic substrate that has been covalently modified to increase its hydrophobicity are separate sheets of material which are abutted in an appropriate orientation to one another.

Closed channels may have varied dimensions depending on the applications for the microfluidic device. In certain embodiments, the open channel has a width of less than about 5 mm, more preferably less than about 3 mm, more preferably less than about 1 mm, most preferably less than about 500 microns. In certain embodiments, the closed channel has a height of less than about 1 mm, more preferably less than about 500 microns, most preferably less than about 200 microns.

Closed channel microfluidic devices can include one or more closed channels. In some cases, the closed channel microfluidic device contains one or more closed channels ranging in length from about 100 microns to about 10 cm. The closed channels may be linear in shape, or they may have any other configuration required for device function, including a curved configuration, spiral configuration, angular configuration, or combinations thereof. Closed channels may also be fabricated to form a 2-dimensional or 3-dimensional fluid flow path. In some cases, two or more closed channels may converge into a single closed channel. Such a design may be incorporated into a closed channel device, for example, to combine two or more liquids within a microfluidic device. Similarly, two or more closed channels may diverge from a single closed channel. Closed channels may intersect in a variety of fashions, including Y-shaped intersections, T-shaped intersections, and crosses.

Closed channel microfluidic devices may further include fluid inlets, assay regions, and combinations thereof.

1. Porous Hydrophilic Substrates

Any porous, hydrophilic substrate that wicks fluids by capillary action can form a closed channel.

Examples of suitable porous hydrophilic substrates include paper, cellulose derivatives, such as nitrocellulose or cellulose acetate, non-woven fabrics, woven fabrics, and hydrophilic, porous polymer films. In certain embodiments, the porous hydrophilic substrate is paper, such as chromatography paper, card stock, filter paper, vellum paper, printing paper, wrapping paper, ledger paper, bank paper, bond paper, blotting paper, drawing paper, fish paper, tissue paper, paper towel, wax paper, or photography paper.

In certain embodiments, the porous hydrophilic substrate has an average pore size large enough to permit one or more analytes to pass through the closed microfluidic channel. In other embodiments, the porous hydrophilic substrate has an average pore size which inhibits the flow of one or more components of a fluid sample through the open channel. In this way, the porous hydrophilic paper can function as a filter to remove components of above a certain particle size or polarity from a fluid sample.

2. Hydrophobic Cellulosic Substrates

Closed channel microfluidic devices are formed from a cellulosic substrate that has been covalently modified to increase its hydrophobicity. The cellulosic substrate can be covalently modified using any suitable methodology, as discussed below.

The cellulosic substrate may be any of the modified cellulosic substrate materials discussed above. Preferably, the cellulosic substrate is paper, such as chromatography paper, card stock, filter paper, vellum paper, printing paper, wrapping paper, ledger paper, bank paper, bond paper, blotting paper, drawing paper, fish paper, tissue paper, paper towel, wax paper, and photography paper.

In certain embodiments, the cellulosic substrate is paper having a grammage, expressed in terms of grams per square meter (g/m²), of greater than 50, 60, 70, 75, 85, 100, 125, 150, 175, 200, 225, or 250.

Generally, the covalently modified cellulosic substrate is substantially impermeable to aqueous solutions. In preferred embodiments, the covalently modified cellulosic substrate has a contact angle with water, as measured using a goniometer, of more than 90° (i.e., it is hydrophobic). In particular embodiments, the covalently modified cellulosic substrate has a contact angle with water of more than about 95°, 100°, 105°, 110°, 115°, 120°, 125°, 130°, 135°, 140°, 145°, 150°, or 155°.

In certain embodiments, the covalently modified cellulosic substrate has a high gas (oxygen) permeability. In preferred embodiments, the covalently modified cellulosic substrate has a gas (oxygen) permeability of greater than about 5,000 Barrer, more preferably greater than about 10,000 Barrer, more preferably greater than about 25,000 Barrer, more preferably greater than about 50,000 Barrer. In certain embodiments, the covalently modified cellulosic substrate has a gas (oxygen) permeability of greater than about 75,000 Barrer.

If desired, the cellulosic substrate may be affixed to or secured within a polymer, metal, glass, wood, or paper support structure to facilitate handling and use of the microwell microfluidic device.

3. Covers

Closed channel microfluidic devices can further include a cover. The cover can be any of the covers described above.

In preferred embodiments, the cover is an adhesive sheet or tape that is adhered to the surface of both the cellulosic substrate and the porous hydrophilic substrate, such that the porous hydrophilic substrate is bounded by a hydrophilic material along all axes other than the axis along which fluid flows. Any suitable adhesive tape can be used. Examples of suitable adhesive tapes include Scotch Tape 600, Scotch Tape 610, Scotch Tape 810, and Scotch Tape 811 (available from 3M, Minneapolis Minn.).

In other embodiments, the cover is formed from a cellulosic substrate that has been covalently modified to increase its hydrophobicity. In these cases, the cellulosic substrate can be affixed to the surface of the microfluidic device using an adhesive.

4. Fluid Inlets and Assay Regions

Closed channel microfluidic devices may further include fluid inlets, assay regions, and combinations thereof.

In certain cases, closed channel microfluidic devices include a single fluid inlet for the introduction of a liquid sample to be processed. In other cases, closed channel microfluidic device include multiple fluid inlets. Generally, one or more fluid inlets are fluidly connected to each microfluidic network in the closed channel microfluidic device. The number of fluid inlets in the device may be governed by the intended function of the device.

The one or more fluid inlets may be regions of porous hydrophilic substrate fluidly connected to the closed, and laterally bounded by an impermeable hydrophobic material. In these cases, fluid may be introduced by applying a fluid to the surface of the porous hydrophilic substrate, such that it is wicked into the closed channel.

The one or more fluid inlets can be fabricated from flangeless ferrules and standard tubing, as discussed above. The ferrules are positioned over one or more microfluidic features, such that the interior of the ferrules is fluidly connected to the microfluidic network. The ferrules can be affixed to the surface of the microfluidic device using any suitable means, such as double-sided adhesive tape or a conventional adhesive. Tubing, such as polyethylene tubing, can be connected to the microfluidic network via the ferrule to form a fluid inlet.

Closed channel microfluidic devices may include one or more assay regions fluidly connected to a network of microfluidic channels. The one or more assay regions may be formed from a porous hydrophilic substrate fluidly connected to the microfluidic network, and laterally bounded by an impermeable hydrophobic material. The porous hydrophilic substrate may be any porous, hydrophilic substrate that wicks fluids by capillary action. Examples of suitable porous hydrophilic substrates include paper, cellulose derivatives, such as nitrocellulose or cellulose acetate, non-woven fabrics, woven fabrics, and hydrophilic, porous polymer films. In certain embodiments, the porous hydrophilic substrate is paper, such as chromatography paper, card stock, filter paper, vellum paper, printing paper, wrapping paper, ledger paper, bank paper, bond paper, blotting paper, drawing paper, fish paper, tissue paper, paper towel, wax paper, or photography paper.

In some cases, the one or more assay regions may include one or more assay reagents that serve as indicators for the presence of one or more analytes, as discussed above. The one or more assay regions may also include an electrode assembly that can be used to detect or quantify one or more analytes within a liquid sample.

5. Valves

Closed channel microfluidic devices may contain one or more valves to actuate fluid flow through the device.

For example, the valves can be made by introducing a gap within the porous hydrophilic substrate which fills the closed channel. A piece of porous hydrophilic substrate can selectively be brought into contact with the substrate on either side of this gap. When present, the piece of hydrophilic substrate bridges this gap, allowing fluid to flow through the closed channel. This can be achieve using stimuli responsive materials or through a twist-type valve.

Valves can also be fabricated by covalently modifying a region of the cellulosic substrate to form a stimuli-responsive (i.e., switchable) hydrophobic coating. In these embodiments, the substrate is modified with a reagent to increase its hydrophobicity which is responsive to external stimuli, such that one or more external stimuli can induce a change in substrate hydrophobicity/-hydrophilicity. For example, the cellulosic substrate may be modified by attaching a hydrophobic molecule via a labile linkage that is cleaved in response to an external stimulus, such as a pH, temperature, ionic strength of a solution, external radiation (e.g., UV light), or any combination thereof. In these cases, an external stimulus, such as a change in the pH of a fluid flowing through a microfluidic channel, can trigger a decrease in hydrophobicity, altering fluid flow.

Valves can also be formed by filling the pores in the paper with a hydrophilic material (which may be optionally stimuli-responsive) or by increasing the density of cellulosic fibers at a point of interest to slow fluid flow.

C. Microwell Microfluidic Devices

Microwell microfluidic devices contain one or more microwells. In certain embodiments, the microwell microfluidic devices contain one or more microwells in combination with one or more additional microfluidic features, such as one or more microfluidic channels. In other embodiments, the microwell microfluidic device contains exclusively microwells.

Microwells are chambers, voids, or depressions formed within a cellulosic substrate that has been covalently modified to increase its hydrophobicity. Each microwell typically has a volume of less than one milliliter, and is capable of holding and retaining a solid or liquid sample.

The microwells may be formed in a variety of shapes and dimensions as desired for particular applications. Generally, the microwells are formed within the cellulosic substrate so as to possess a solid bottom, one or more solid side walls, and an opening located on the surface of the microfluidic device. Alternatively, the microwells can be in the form of a hemispherical bowl.

The microwells can have any suitable shape. For example, the microwells can be circular, ovoid, quadrilateral, rectangular, square, triangular, pentagonal, hexagonal, heptagonal, or octagonal. In some embodiments, the microwells are rectangular in shape. In these instances, the shape of the microwells can be defined in terms of the length of the four side walls forming the perimeter of the rectangular microwell.

In preferred embodiments, the microwells are spherical in shape. In certain embodiments, the microwells are circular, and have a diameter of between 3 and 100 mm, more preferably between 5 and 80 mm. For certain applications, the microwells are circular, and have a diameter of between 3 and 10 mm, more preferably between 5 and 8 mm, most preferably between 6.5 and 7.0 mm. For other applications, the microwells are circular and large, with a diameter of between 50 and 80 mm.

The depth of the microwells, governed by the height of the solid side walls forming the microwells, can vary to provide microwells having the desired volume and/or volume-to-surface-area ratio for particular applications. In certain instances, the depth of the microwells ranges from about 25 microns to about 1 mm, more preferably from about 50 microns to about 500 microns, most preferably from about 100 to about 500 microns.

The microwells may be arranged within the cellulosic structure in a variety of geometries depending upon the overall shape of the microfluidic device. For example, in some embodiments, the microwells are arranged in rectangular or circular arrays. In the case of microwell microfluidic plates containing a plurality of microwells, the microwells may be equally spaced from one another or irregularly spaced. In preferred embodiments, the edges of neighboring microwells are separated by at least about 50 microns, more preferably at least about 75 microns, most preferably at least about 100 microns. In certain embodiments, the edges of neighboring microwells are separated by at least about 100 microns, about 200 microns, about 300 microns, or about 400 microns.

In particular embodiments, the microwell microfluidic device contains an array of microwells arranged in a 2:3 rectangular matrix, so as to form a microwell plate (also known as a microtiter plate). In some cases, the microwell microfluidic device has a total of six, 24, 96, 384, 1536, 3456, or 9600 microwells arranged in a 2:3 rectangular matrix.

In certain embodiments, the microwell plate has one or more dimensions, including well diameter, well spacing, well depth, well placement, plate dimensions, plate rigidity, and combinations thereof, equivalent to the standard dimensions for microwell plates published by the American National Standards Institute (ANSI) on behalf of the Society for Biomolecular Sciences (SBS). In this way, the microwell microfluidic devices can be rendered compatible with existing technologies for plastic microtiter plates, including 8-channel micropipettes and automated plate readers.

1. Cellulosic Substrates

Microwell microfluidic devices are formed from a cellulosic substrate that has been covalently modified to increase its hydrophobicity. The cellulosic substrate can be covalently modified using any suitable methodology, as discussed below.

The cellulosic substrate may be any of the modified cellulosic substrate materials discussed above. Preferably, the cellulosic substrate is paper, such as chromatography paper, card stock, filter paper, vellum paper, printing paper, wrapping paper, ledger paper, bank paper, bond paper, blotting paper, drawing paper, fish paper, tissue paper, paper towel, wax paper, and photography paper.

In certain embodiments, the cellulosic substrate is paper having a grammage, expressed in terms of grams per square meter (g/m²), of greater than 50, 60, 70, 75, 85, 100, 125, 150, 175, 200, 225, or 250.

Generally, the covalently modified cellulosic substrate is substantially impermeable to aqueous solutions. In preferred embodiments, the covalently modified cellulosic substrate has a contact angle with water, as measured using a goniometer, of more than 90° (i.e., it is hydrophobic). In particular embodiments, the covalently modified cellulosic substrate has a contact angle with water of more than about 95°, 100°, 105°, 110°, 115°, 120°, 125°, 130°, 135°, 140°, 145°, 150°, or 155°.

In certain embodiments, the covalently modified cellulosic substrate has a high gas (oxygen) permeability. In preferred embodiments, the covalently modified cellulosic substrate has a gas (oxygen) permeability of greater than about 5,000 Barrer, more preferably greater than about 10,000 Barrer, more preferably greater than about 25,000 Barrer, more preferably greater than about 50,000 Barrer. In certain embodiments, the covalently modified cellulosic substrate has a gas (oxygen) permeability of greater than about 75,000 Barrer.

If desired, the cellulosic substrate may be affixed to or secured within a polymer, metal, glass, wood, or paper support structure to facilitate handling and use of the microwell microfluidic device. For example, the cellulosic substrate may be affixed to or secured within a plastic frame or block in order allow the microwell microfluidic device to be processed using standard instrumentation for microtiter plates, such as automated plate readers. The support structure may also be piece of polymer, metal, glass, wood, or paper designed to increase the rigidity of the microwell microfluidic device.

2. Assay Reagents

If desired, one or more of the microwells within a microwell microfluidic device may be treated with one or more assay reagents, as described above.

### III. Methods of Manufacture

The appropriate methods for fabrication of the microfluidic devices can be selected in view of the type of microfluidic features present in the device, as well as the overall device design.

Generally, fabrication of the microfluidic devices includes formation of a network of microfluidic components, covalent modification of a cellulosic substrate to increase its hydrophobicity, and application of a cover (when present). Fabrication may further include fabrication of one or more assay regions, treatment of assay regions with one or more assay reagents, and attachment of one or more additional elements, such as fluid inlets and/or fluid outlets.

In some cases, the cellulosic substrate is covalently modified to increase its hydrophobicity prior to the formation of the microfluidic network. In other cases, microfluidic network is first formed, and then the cellulosic substrate is covalently modified to increase its hydrophobicity.

In certain embodiments, information may be printed on one or more layers of the microfluidic device using, for example, conventional ink-jet printing or laser printing. For example, instructions for using the microfluidic device, labels identifying microfluidic features within the device, and reference information for the interpretation of assays regions may be printed on the microfluidic device to facilitate its use.

Microfluidic devices can be fabricated into appropriate two- or three-dimensional shapes using a variety of methods. The cellulosic substrate, covers, and porous hydrophilic substrates can be mechanically cut, for example, by using a scissor, laser cutter, blade, knife, dye, or punch, to form a microfluidic device having the desired overall shape. In certain embodiments, the cellulosic substrate, covers, and porous hydrophilic substrates may also be perforated to facilitate folding or separation of the microfluidic devices after fabrication.

If desired, the shape of the device (and device components) can be designed on a computer using a layout editor (e.g., Autocard®, SolidEdge, Adobe® Illustrator, Clewin, WieWeb Inc.) or standard computer aided drafting software. The computer can be integrated with a laser cutter to automatically pattern the microfluidic device, and components thereof, into their desired shapes.

Microfluidic devices can be mass produced by incorporating highly developed technologies for automatic paper cutting, folding, embossing, etching, stacking, and screen-printing. In particular embodiments, the microfluidic devices are fabricated in series on a roll (e.g., roll-to-roll or reel-to-reel printing), or in the form of a single sheet containing multiple devices. In these embodiments, the cellulosic substrate may be perforated to facilitate separation of one or more microfluidic devices from the roll or sheet. Adhesives can be applied to the devices using methods known in the art, for example, by rotogravure printing, knife coating, powder application, or spray coating. Suitable methods of application can be selected based on the surface(s) to the coated as well as the nature of the adhesive being applied. Adhesive can be applied to the devices, in a manner similar to labels, to permit the devices to be adhered to a surface.

A. Formation of the Microfluidic Network

1. Methods of Fabricating Open Microfluidic Channels

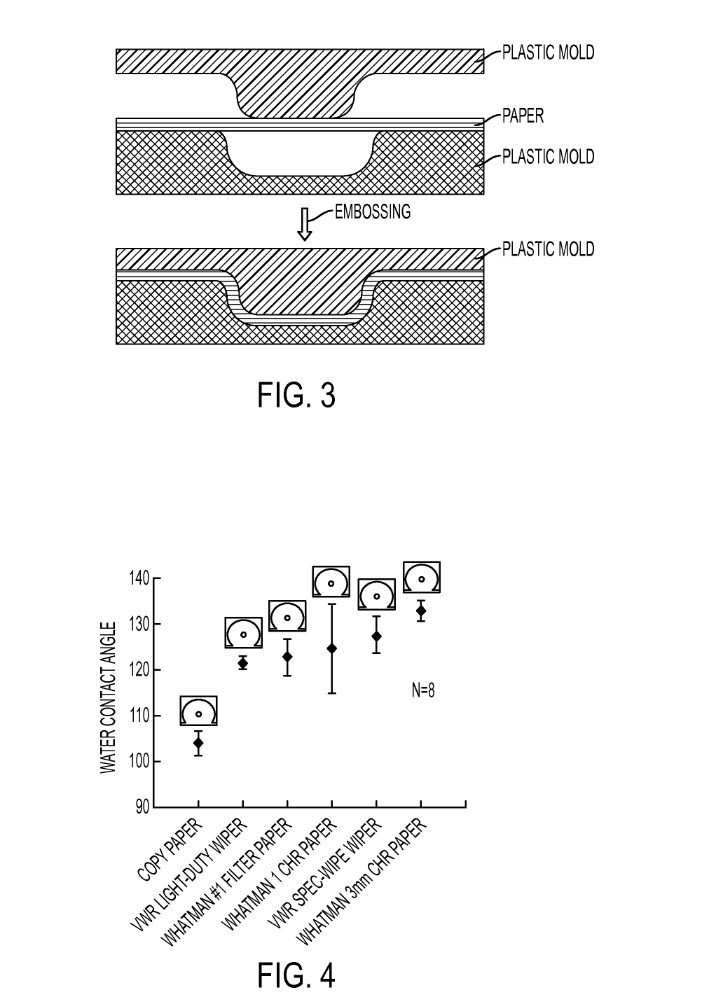

Open microfluidic channels can be fabricated by embossing, stamping, or impressing a cellulosic substrate. An exemplary method for forming an open microfluidic channel by embossing a cellulosic is illustrated in FIG. 3.

Open channels can be embossed using a pair of dies (i.e., positive and negative) having complementary shape and appropriate design for the desired channel. A sheet of cellulosic substrate can then be placed between the pair of dies, and pressure is applied to emboss the cellulosic substrate, forming the open channel within the cellulosic substrate. Suitable dies can be fabricated from a variety of materials, including metals, polymers, and combinations thereof. The dies can be designed using a computer, and formed using any suitable technique, such as thermoplastic casting or laser cutting. In preferred embodiment, polymeric dies were fabricated using a 3-D printer. To make embossing easier, the glass transition temperature of the cellulosic fibers can be lowered by wetting the paper substrate with the appropriate solvents (e.g., ethanol or acetone), then embossing the wet paper.

Open channel microfluidic channels can also be fabricated by etching or carving a microfluidic channel into the cellulosic substrate. For example, microfluidic channels can be etched into a cellulosic substrate using a digital craft cutter, such as a Silhouette Cameo™, equipped with a thin blade or engraving tip.

In preferred embodiments, the open channels are first formed in the cellulosic substrate, and subsequently the cellulosic substrate is covalently modified to increase its hydrophobicity. Alternatively, the open channels can be formed in a cellulosic substrate that has previously been covalently modified to increase its hydrophobicity. A cover can subsequently be applied to the cellulosic substrate to seal the open channel.

Open channel microfluidic devices, particularly 3D open channel microfluidic devices, can be fabricated by stacking layers of substrate material which have been appropriately fabricated with one or more microfluidic features.

An exemplary method for forming an open microfluidic channel by stacking layers of substrate material (paper and double-sided tape) is described in Example 7. First, each layer of substrate material is patterned with the desired microfluidic components. If desired, a layout editor (e.g., Autocard®, SolidEdge, Adobe® Illustrator, Clewin, WieWeb Inc.) or standard computer aided drafting software can be used to design each layer of substrate material. The substrate material is then mechanically cut to form the microfluidic features, for example, by using a scissor, laser cutter, blade, knife, dye, or punch. The fabricated layers of substrate material are then stacked to assemble the device.

Stacking can also be used to make 3D microfluidic devices on a single sheet of paper. For example, a single sheet of paper with double sided tape adhered to one or both sides of the paper can be etched to form a variety of microfluidic features which, when the paper is appropriately folded, form a 3-dimensional microfluidic device. The single layer of paper and tape can then be put into an envelope and transported to the field. Upon arrival, the protective film of the double-sided tape is peeled off and the paper/tape is folded and assembled into functional 3D microfluidic devices.

2. Methods of Fabricating Closed Microfluidic Channels

Closed microfluidic channels can be fabricated from a porous, hydrophilic substrate (such as paper), a cellulosic substrate that was covalently modified to increase its hydrophobicity, and a cover (Scotch® tape).

Typically, the porous, hydrophilic substrate is first patterned to form the shape of the closed channel. The porous hydrophilic substrate may be mechanically cut, for example, by using a scissor, laser cutter, blade, knife, dye, or punch, to form a microfluidic device having the desired overall shape. The patterned porous, hydrophilic substrate can then be placed one top of a sheet of a cellulosic substrate that was covalently modified to increase its hydrophobicity. If desired, a complimentary recess may be etched into the cellulosic substrate, so as to receive the porous, hydrophilic substrate. A cover can subsequently be applied over the porous, hydrophilic substrate and the cellulosic substrate, so as to seal the closed channel.

3. Methods of Fabricating Microwells

Microwells can be fabricated by embossing, stamping, impressing, stacking, or impressing a cellulosic substrate.

Microwells can be embossed using a pair dies (i.e., positive and negative) having complementary shape and appropriate design for the desired microwell. A sheet of cellulosic substrate can then be placed between the pair of dies, and pressure is applied to emboss the cellulosic substrate, forming the microwell within the cellulosic substrate. Suitable dies can be fabricated from a variety of materials, including metals, polymers, and combinations thereof. The dies can be designed using a computer, and formed using any suitable technique, such as thermoplastic casting or laser cutting. In preferred embodiment, polymeric dies were fabricated using a 3-D printer.

Microwells can also be fabricated by stacking appropriately cut paper, as described above.

B. Covalent Modification of the Cellulosic Substrates

Cellulosic substrates, such as paper, are covalently modified to increase their hydrophobicity.

The cellulosic substrates can be covalently modified using any suitable synthetic methodology. For example, hydroxyl groups present on the surface of the cellulosic substrate may be covalently functionalized by silanization, acylation, or by epoxide, aziridine, or thiirane ring opening. In preferred embodiments, the cellulosic substrate is treated with a volatile reagent to increase its hydrophobicity.

In some cases, the surface hydroxyl groups of the cellulosic substrate (i.e., the cellulose fibers) are reacted with a volatile, hydrophobic silane to form surface silanol linkages. Suitable silanes include linear or branched alkyl-, fluoroalkyl-, or perfluoroalkyl-trihalosilanes, and alkylaminosilanes. In certain embodiments, the cellulosic substrate is reacted with one or more fluoroalkyl-, or perfluoroalkyl-trichlorosilanes, such as (tridecafluoro-1,1,2,2-tetrahydrooctyl)trichlorosilane, to form a fluorinated, highly textured, hydrophobic surface on the cellulosic substrate. In other embodiments, the cellulosic substrate is covalently modified with a silane that does to produce toxic byproducts, such as HF, upon combustion. For example, the cellulosic substrate can reacted with an alkylaminosilane, such as tris(dimethylamino)silane to increase the hydrophobicity of cellulosic substrate. Silanization of paper with an alkyl or fluoroalkyl trichlorosilane makes it hydrophobic; the reaction occurs readily with the silanizing agent in the vapor phase, and requires no equipment apart from a low-pressure chamber and a source of heat.

The silanization treatment does not degrade the physical properties of the paper and does not require pre- or post-treatment steps (e.g. washing to remove reagents or side products, drying, etc.). Of the commercially available silanes, (3,3,4,4,5,5,6,6, 7,7,8,8,9,9,10,10,10-heptadecafluorodecyl)trichlorosilane, CF₃—(CF₂)₇—CH₂—CH₂—SiCl₃ (C₁₀^{F}), and decyl trichlorosilane, CH₃(CH₂)₉—SiCl₃ (C₁₀^{H}) are volatile and reactive toward the hydroxyl groups of cellulose. This silanization reaction generates highly hydrophobic surfaces on the cardstock paper (static contact angles of water θ_{S}^{C10F}=137°±4°, n=20 and θ_{S}^{C10G}=131°±5°, n=20). Paper functionalized with C₁₀^{F} is also oleophobic (contact angle with hexadecane θ_{S}^{C10F}=93±3°, N=10). In contrast, paper functionalized with C₁₀^{H} is wet by hexadecane. The paper can be silanized before or after carving the microfluidic channels. However, silanizing after introduction of the microfluidic channels can avoid damaging the silane layer or exposing cellulose fibers that had not come in contact with vapors of organosilane.

In another embodiment, the surface hydroxyl groups of the cellulosic substrate are acylated by reaction, for example, with one or more hydrophobic groups functionalized with an acid chloride. Examples of suitable hydrophobic groups include linear, branched, or cyclic alkyl groups: linear, branched, or cyclic alkenyl groups; linear, branched, or cyclic alkynyl groups, aryl groups, heteroaryl groups, optionally substituted with between one and five substituents individually selected from linear, branched, or cyclic alkyl, linear, branched, or cyclic alkenyl, linear, branched, or cyclic alkynyl, alkoxy, amino, halogen, nitrile, CF₃, ester, amide, aryl, and heteroaryl. The hydrophobic group may also be a fluorinated or perfluorinated analogs of any of the groups described above. In preferred embodiments, the hydrophobic group is an aryl ring substituted with one or more fluorine atoms and/or trifluoromethyl groups, or a linear or branched alkyl group substituted with one or more halogen atoms. The introduction of halogenated functional groups via glycosidic linkages increases the hydrophobicity of the cellulosic surface.

The cellulosic substrate can also be covalently modified by treatment with a hydrophobic group substituted with one or more epoxide or thiirane rings. Examples of suitable hydrophobic groups include linear, branched, or cyclic alkyl groups; linear, branched, or cyclic alkenyl groups; linear, branched, or cyclic alkynyl groups, aryl groups, heteroaryl groups, optionally substituted with between one and five substituents individually selected from linear, branched, or cyclic alkyl, linear, branched, or cyclic alkenyl, linear, branched, or cyclic alkynyl, alkoxy, amino, halogen, nitrile, CF₃, ester, amide, aryl, and heteroaryl. The hydrophobic group may also be a fluorinated or perfluorinated analogs of any of the groups described above.

Cellulosic substrates can also be covalently modified by grafting hydrophobic polymers, such as polyesters, to the cellulosic substrate. For example, poly(ε-caprolactone) and polylactic acid can be grafted to cellulose fibers by ring opening polymerization, forming a hydrophobic cellulosic surface. Methods of grafting hydrophobic polymers to cellulose are known in the art. See, for example, Lönnberg et al. Biomacromolecules. 7:2178-2185 (2006).

The hydrophobicity/hydrophilicity of the covalently modified cellulosic substrate can be quantitatively assessed by measuring the contact angle of a water droplet on the substrate surface using a goniometer. The hydrophobicity/hydrophilicity of the covalently modified cellulosic substrate can be qualitatively assessed by rolling droplets of water on the surface of the modified paper to evaluate the wettability of the surface.

Covalent attachment of the modifying reagent to the cellulosic substrate can be confirmed using appropriate molecular and surface analysis methods, including reflectance FTIR and XPS. In certain embodiments, at least 5%, more preferably at least 25%, more preferably at least 35%, more preferably at least 50%, most preferably at least 75% of the pendant —OH groups present on the cellulosic backbone are covalently modified. In certain embodiments, more than 80% of the pendant —OH groups present on the cellulosic backbone are covalently modified.

In certain embodiments, the cellulosic substrate is modified by reaction with a small molecule. In certain embodiments, the cellulosic substrate is covalently modified with a reagent that has a molecular weight of less than about 1500 g/mol, more preferably less than about 1000 g/mol, most preferably less than about 800 g/mol. In certain cases, the cellulosic substrate is not covalently modified by attachment of a polymer or polymers.

### IV. Methods of Use

Microfluidic devices can be used to analyze one or more fluid samples. In certain embodiments, the microfluidic devices are used to detect a variety of analytes based of the design of the microfluidic device, including small molecules, proteins, lipids, polysaccharides, nucleic acids, prokaryotic cells, eukaryotic cells, particles, viruses, metal ions, and combinations thereof.

In some cases, the microfluidic devices are used to conduct point-of-care diagnostic testing. In these embodiments, the microfluidic devices can be designed to operate without any supporting equipment, such as personal computers, pumps, or external instrumentation. For example, the microfluidic device may contain one or more assay regions containing one or more assay reagents selected so as to provide a response that is visible to the naked eye.

In some cases, the assay reagent can be an indicator that exhibits colorimetric and/or fluorometric response in the presence of the analyte of interest. Indicators may include molecules that become colored in the presence of the analyte, change color in the presence of the analyte, or emit fluorescence, phosphorescence, or luminescence in the presence of the analyte.

In these embodiments, the presence of an analyte may be ascertained by simple visual examination, optionally under a blacklight. In some cases, the quantity of one or more analytes may be determined by visual inspection of the color or fluorescence of an assay region, for example, by comparison to known colors at predetermined analyte concentrations. Alternatively, a portable device, such as a digital camera, flatbed scanner, or cellular phone may used to analyze the response of the analyte region.

In other embodiments, the microfluidic device may be used in conjunction with external instrumentation. For example, a microfluidic device may contain one or more fluid outlets that connect the microfluidic network to one or more external instruments, such as a mass spectrometer, fluorometer, UV-Vis spectrometer, IR spectrometer, gas chromatograph, gel permeation chromatograph, DNA sequencer, Coulter counter, or combinations thereof, that can be used to analyze the fluid flowing from the microfluidic network. The microfluidic device may also contain one or more assay reagents are selected to facilitate radiological, magnetic, optical, and/or electrical measurements used to identify and/or quantify one or more analytes in a liquid sample.

Microfluidic devices can be used to analyze a variety of biological fluids, including blood, urine, plasma, serum, tears, lymph, bile, cerebrospinal fluid, interstitial fluid, aqueous or vitreous humor, colostrum, sputum, amniotic fluid, saliva, anal and vaginal secretions, perspiration, semen, transudate, exudate, and synovial fluid.

In certain embodiments, the microfluidic devices are used to perform a lateral flow-type immunoassay, for example, to detect pregnancy, fertility, narcotics, HIV, Troponin T, malaria, Avian Flu, respiratory diseases, sickle cell anemia, or combinations thereof.

Microfluidic devices can be used to analyze environmental samples, including water and soil samples, for example, to detect or quantify one or more heavy metals within a sample. Microfluidic devices can also be used in quality control applications, including the analysis of food samples and pharmaceutical products.

Open channel microfluidic devices may be particularly well suited to processing samples containing suspended particles or large molecules, such as blood, environmental slurries, multi-phase suspensions, and other raw biological samples.

In certain embodiments, an open channel microfluidic device is used to analyze a sample containing large macromolecules (such as DNA, RNA, and combinations thereof), suspended cells, viruses, particles, or combinations thereof which cannot be transported by wicking through a porous, hydrophilic substrate, such as paper.

In particular embodiments, the open channel microfluidic devices are used to identify and/or quantify a pathogen, such as a bacteria, protest, or virus, in a biological sample. In another embodiment, the open channel microfluidic device is used to identify and/or quantify cells in a biological solution.

Open channel microfluidic devices may also be used to prepare and/or isolate microparticles and nanoparticles. Microfluidic devices may also be useful for performing and/or optimizing polymerase chain reactions (PCRs).

Microfluidic devices may also be used in controlled crystal engineering. For example, the microfluidic devices can be used to selectively prepare desirable polymorphs of pharmaceuticals. Microfluidic devices can also be used to determine optimal conditions for protein crystallization.

Microfluidic devices may also be used to separate and/or purify samples, including complex biological samples. Electrophoresis can be performed within open channel microfluidic devices to separate ionic species, including biomolecules. Microfluidic devices may also be used in chromatographic separations (e.g., protein fractionation), for example, by filling an open microfluidic channel with a size exclusion or ion exchange resin.

Microfluidic devices may also be used in removing vapors from a liquid-vapor solution making use of the high gas permeability of paper.

The gas permeability of paper renders paper-based microfluidic devices useful for growing biological cultures. For example, paper-based microfluidic devices can be used for cell culture (i.e., the culture of cells derived from multicellular eukaryotes, especially animals such as humans). Paper-based microfluidic devices can also be used to culture plant cells, fungi cells, and microbes, including viruses, bacteria and protists. When used for applications in biological cultures, the cellulosic substrate provided for the venting/aerating of the biological cultures whilst serving as a barrier against contaminants, such as bacteria. Microfluidic devices can also be used to oxygenate blood or other biofluids.

The gas permeability of covalently modified paper also renders these paper-based microfluidic devices useful for the detection of gas-phase analytes.

Paper-based microfluidic devices may also find applications in infochemistry.

### EXAMPLES

### Example 1

### Covalent Modification of Paper to Increase Hydrophobicity

Paper was covalently modified to increase its hydrophobicity. The paper surface can be rendered hydrophobic by reaction of the paper (cellulose) fibers with appropriate hydrophobic moieties (e.g., silanization with alkyl and/or fluoroalkyl trichlorosilanes, acylation with hydrophobic groups, or combinations thereof). By using different types of chemical reactions to introduce fluorinated and non-fluorinated groups, the hydrophobicity of the paper surface can be increased.

Procedure and Result

Hydrophobic Paper

To render paper hydrophobic, the hydroxyl groups of the paper cellulose fibers were functionalized with (tridecafluoro-1,1,2,2-tetrahydrooctyl)trichlorosilane vapor. This reaction forms surface silanol linkages, and renders the paper surface hydrophobic, as shown in Scheme 1A. Six types of paper were silanized with (tridecafluoro-1,1,2,2-tetrahydrooctyl)trichlorosilane vapor, and the hydrophobicity of the covalently modified paper surfaces was quantified by measuring their water contact angles using a contact angle goniometer.

As shown in FIG. 4, covalent modification increases the water contact angle of the paper surface. The six modified paper substrates exhibited water contact angles ranging from approximately 105 degrees to approximately 147 degrees. Among the types of paper examined, Whatmann 3 mm chromatography paper provided the highest contact angle with water (132.9°±2.3°) after silanization.

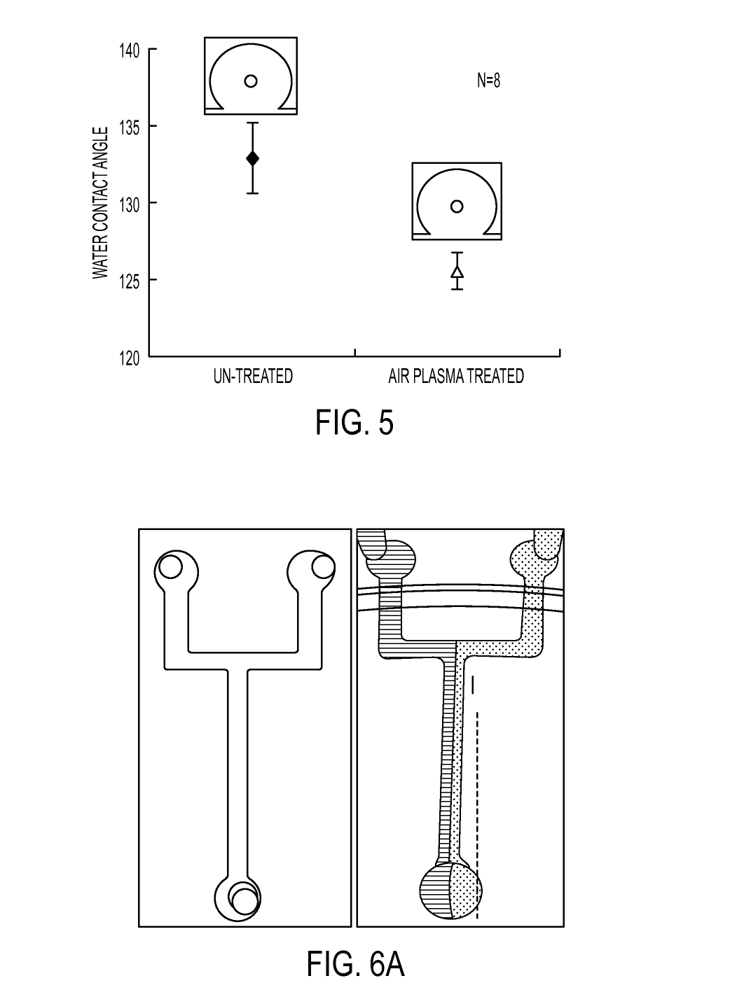

Whatmann 3 mm chromatography paper was also treated by air plasma for two minutes prior to silanization. As shown in FIG. 5, the paper pre-treated with plasma prior to silanization exhibited a lower water contact angle (125.5°±1.2°) than the un-treated substrate (132.9°±2.3°).

### Fluorinated Aryl Ester Paper v. Silanized Paper

To render paper hydrophobic, the hydroxyl groups of the paper cellulose fibers were also reacted with acyl chlorides (either 6-bromo hexanoyl chloride or 3,5-bis(trifluoromethyl)benzoyl chloride), forming labile glycosidic bonds (Scheme 1B). The contact angles between water and the fluorinated aryl ester paper was approximately 132°, slightly lower than was obtained by silanization (Table 1). When the paper is acylated with 6-bromo hexanoyl chloride, it readily wicks water on contact.

TABLE 1

Contact angle

| Liquid | Acylated | Silanized |
|---|---|---|
| DI Water | 132.1 | 141 |
| PBS 1X, pH 7 | 132.6 | 140 |
| Phosphate buffer, pH 7 | 129.3 | 140.2 |
| Tris, pH 8.3 | Wicks | 141.5 |

The contact angle measurements were performed by a contact angle goniometer (Ramé-Hart model 100, Ramé-Hart Instrument Co.) at room temperature (20-25° C.) with ˜20% relative humidity. The droplet volume for the measurement was ˜10 μL (unless otherwise specified).

Chemistry

Scheme 1 shows the reaction of cellulose with a silanizing and acylating reagents, as discussed above. In reaction A, silanization is achieved by reaction of the surface hydroxyls with a trichlorosilane. In this example, the covalently modified surface contains exposed fluorinated hydrocarbon chains, rendering the paper hydrophobic. In reaction B, acylation attaches fluoroaryl or bromo alkyl groups via glycosidic esters linkages, resulting in surface exposed halides.

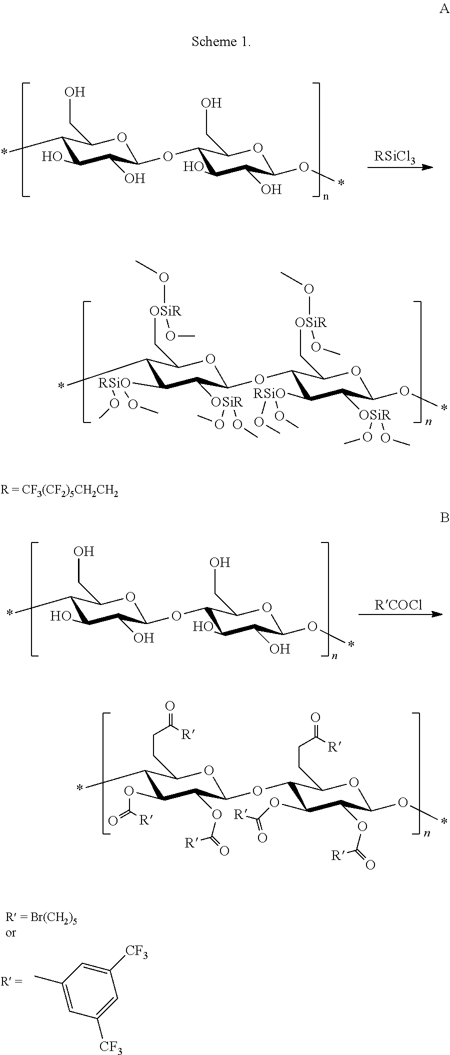

Water v. Buffer

The contact angles for PBS (phosphate buffered saline), Phosphate buffer, and Tris for the treated papers were measured. For the silanized hydrophobic paper, comparable contacts angles for any of the buffers compared to water were observed (˜140°, Table 1). The covalently modified paper did not show any appreciable change in contact angle as a function of contact time, even when leaving the paper in contact with the drops for hours.

In the case of paper acylated using 3,5-bis(trifluoromethyl)benzoyl chloride, the contact angles of buffer solutions at pH 7 (PBS and phosphate buffer) were comparable to water, ˜130° (Table 1). As anticipated, contact angles with Tris buffer (pH 8.3) were not successfully measured, as the paper rapidly lost hydrophobicity, resulting in wicking of the buffer. Contact angles with organic solvents (toluene, hexadecane and perfluorodecalin) were unable to be measured as these solvents readily wetted the paper.

Hydrophobicity after Passage of Water

A piece of the silanized paper was placed on a Hirsch funnel connected to a vacuum line via a side-stemmed Erlenmeyer flask. Copious volumes of water were passed through the silanized paper by pouring water on top of the silanized paper and applying a vacuum. Even upon the repeated passage of large volumes of water, the surface of the paper remained hydrophobic.

Permeability of Hydrophobically-Modified Paper Towards Water Vapor

A sample of silanized paper and a sample of non-silanized paper were placed on a cold surface to allow water to condense on their surfaces. As anticipated, a large condensate was observed. Upon warming to room temperature, water droplets formed on the non-silanized paper surface, while very tiny droplets formed on the silanized paper surface. A small amount of condensate was also visible underneath the silanized paper. This condensate appeared to be the result of condensation of trapped water vapor which diffused through the pores of the hydrophobic paper.

### Example 2

### Fabrication of Open Channel Microfluidic Devices from Hydrophobic Paper by Embossing

An open channel microfluidic device was constructed by embossing open microchannels on Whatmann #1 filter paper.

An exemplary strategy for forming open channels via embossing is illustrated in FIG. 3. Two polymeric dies of complementary shape and appropriate design were fabricated using a 3D printer. An open channel microfluidic device was then fabricated by sandwiching a sheet of Whatmann #1 filter paper, and applying pressure. Following formation of the open channel, the paper was silanized by reaction with perfluorooctyl trichlorosilane (FOTS) vapor.

Scotch® tape was then applied to the surface of the cellulosic substrate, sealing the open channel. Holes were cut through the Scotch® tape cover at the origin of each embossed channel, and inlet tubes, supported by a small amount of PDMS, were inserted to form fluid inlets.

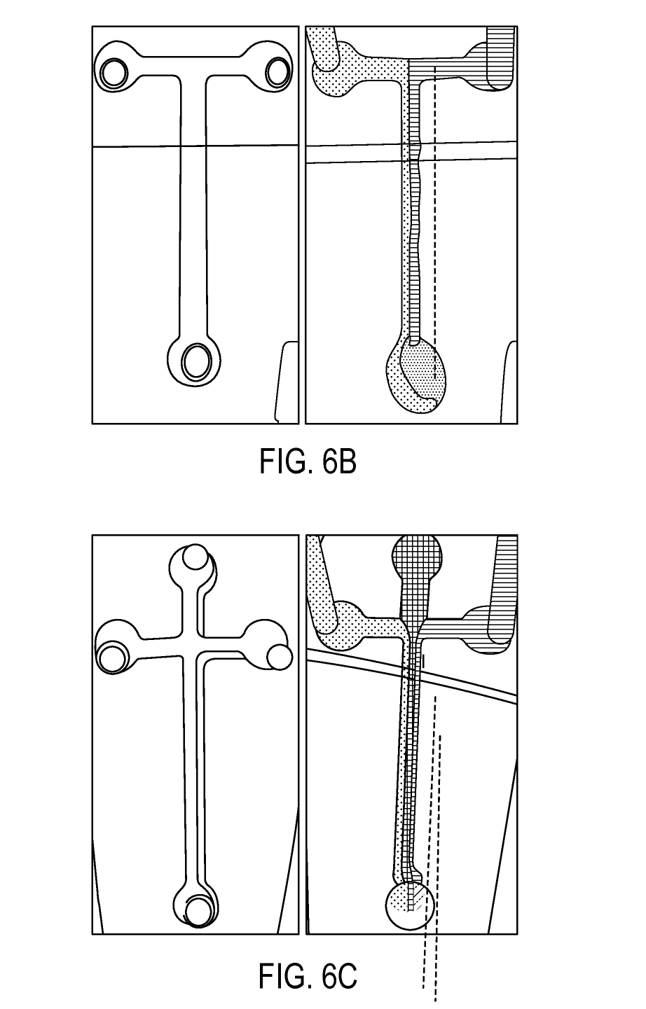

FIGS. 6A-6C show three different open channel microfluidic devices having different architectures. FIG. 6A, left, shows a microfluidic device containing a ‘Y-shaped’ microfluidic channel with two fluid inlets. When aqueous solutions (water dyed different colors for purposes of illustration) are introduced at each of the fluid inlets, the streams of dyed water flowing through the microfluidic channel without mixing due to laminar flow (FIG. 6A, right). Laminar flow was similarly observed in a ‘T-shaped’ microfluidic device having two fluid inlets (FIG. 6B) and a cross-shaped microfluidic device having three fluid inlets (FIG. 6C). In each of the images, dashed lines are used to indicate flow boundaries between differently colored fluids.

### Example 3

### Fabrication of Open Channel Microfluidic Devices from Hydrophobic Paper by Carving/Engraving

Open channel microfluidic devices were also constructed by carving open microchannels on cardstock (approximately 300 microns in thickness).

An exemplary strategy for forming open channels via carving is illustrated in FIG. 7. Open microfluidic channels were first designed using computer-assisted design software (Adobe® Illustrator® CS5, Adobe Systems Incorporated). A digital craft cutter (Silhouette Cameo™) was used to carve the open channels into the surface of the cardstock paper substrate (FIG. 7, panel i).

In some instances, the cardstock was then covalently modified (panel ii) by reaction with tris(dimethylamino)silane. Tris(dimethylamino)silane was selected because it is very volatile, fluorine-free, and undergoes a very fast reaction with the hydroxyl groups of cellulose to render paper hydrophobic, as illustrated in Scheme 2.

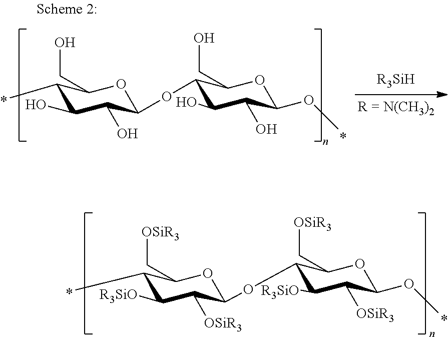

Silanization with tris(dimethylamino)silane does not adversely affect the physical properties of the paper substrate (no HCl is generated), and does not require pre or post treatment steps (such as washing cycles to remove the excess of reagents or side products, drying, etc.). In addition, paper silanized with tris(dimethylamino)silane can be safely disposed of by burning because the organosilane reagent does not contain fluorine atoms, eliminating the risk of producing HF by burning.

The cardstock was treated with tris(dimethylamino)silane vapor for approximately four minutes to generate a paper surface with a static water contact angle of 108.7°±0.8°.

In other instances, the card stock was silanized with 1H,1H,2H,2H, heptadecfluorodecyl trichlorosilane (Gelest). Each experiment typically required approximately 100 mg of heptadecafluorodecyl trichlorosilane (Gelest Inc.) in 5 mL of anhydrous toluene. The silane was vaporized at 95° C. under reduced pressure (˜30 mbar, 0.03 atm) and allowed to react for 5 minutes. Diffusion inside the reaction chamber is sufficient for an even distribution of the silane within the chamber.

Following covalent modification the cover and fluid inlets were attached to the device (panel iii). After hydrophobic treatment of the cellulosic substrate, the top of the open channel was sealed with transparent adhesive tape (Fellowes adhesive sheet). 1 mm holes were cut through the adhesive tape using the craft cutter to form fluid inlets and fluid outlets. Flangeless ferrules (such as P-200NX ferrules available from Upchurch Scientific, Oak Harbor, Wash.) were positioned over the 1 mm holes, and affixed to the surface of the microfluidic device using rings of double-sided adhesive tape (cut using the craft cutter). Polyethylene tubing was inserted into the ferrule to form the fluid inlets.

A syringe pump drove fluid from the inlets to the outlets of the open microchannels at flow rates of 5-100 μL/min. For applications requiring a fixed inlet pressure, rather than a fixed volumetric flow rate, gravity-driven flow was used and the hydrostatic pressure adjusted by controlling the height of our inlet liquid reservoir with respect to the waste reservoirs. The microfluidic device withstood hydrostatic pressures up to 0.27 bar (27 kPa) without delaminating.

The complete sequence of fabrication steps from design concept to a working device was completed within ten minutes: (i) carving of 40 individual devices in a sheet of cardstock paper takes less than 30 seconds (less than a second per device for a simple T-shaped device), (ii) vapor-phase silanization of the entire engraved sheet requires ˜5 minutes, and (iii) the assembly of one device (i.e. affixing adhesive layers and tubing) takes ˜2 minutes.

Optimizing the quality of the seal between the inlets of the device and the fluid supply helps minimize the probability of failure of the devices. Success was defined as the continuous flow of liquid from inlet to outlet under a constant pressure of ˜0.2 bar (20 kPa), for an observation time of at least one hour, without leakage or delamination occurring at fluidic connections or along the fluidic path). To seal the ferrule to the paper device, we used a strong double-sided adhesive tape (3M Command Medium Picture Hanging Strips): no leakage at the ferrule occurred during our observation time (65/65 cases).

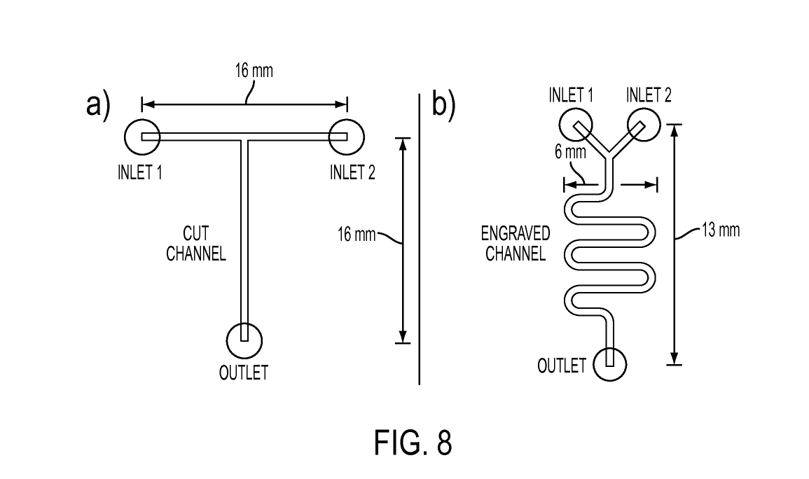

FIG. 8 shows the structure of exemplary microfluidic device formed by cutting (panel a) or etching (panel b). Panel a illustrates a microfluidic device containing a ‘T-shaped’ microfluidic channel, two fluid inlets, and one fluid outlet. Panel b illustrates a microfluidic device containing a serpentine microfluidic channel (i.e., a micromixer), two fluid inlets, and one fluid outlet.

Channels of different widths can be created by choosing appropriate blades to use with the craft-cutting machine: a thin blade generated channels with widths of 45±5 μm (n=5, based on SEM images), whereas an engraving tip generated channels with widths of 100 to 300 μm. In both cases, selecting appropriate settings of the craft-cutter can produce microchannels with depths between 50 and 300 μm. The dimensions of the channels can be controlled by the combination of tip width and craft-cutter settings.

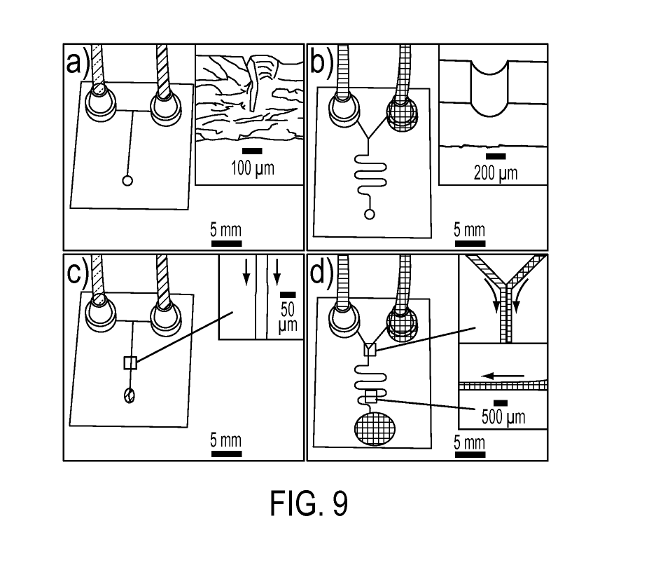

FIG. 9 illustrates the performance of the microfluidic devices illustrated in FIG. 8. Panel a illustrates a microfluidic device containing a ‘T-shaped’ microfluidic channel, two fluid inlets, and one fluid outlet. The inset image illustrates a cross-section of the channel in the boxed region indicated in the larger photograph. When aqueous solutions (water dyed different colors for purposes of illustration) are introduced at each of the fluid inlets, the streams of dyed water flowing through the microfluidic chamiel without mixing due to laminar flow (FIG. 9, panel c). Two miscible aqueous phases, each labeled with a different water-soluble dye (0.05% solutions of Methylene Blue or Congo Red in water), were pumped through a T-junction at a flow rate of 10 μL/min (Reynolds number Re=2). An optical microscope at 50× magnification imaged the two parallel streams within the 45-μm-wide channel (see insets in FIG. 9, panel c). These observations confirm that these devices can reproduce the classical diffusion-limited co-flows reported in open-channel microfluidic devices fabricated in solid materials such as PDMS.

FIG. 9, panel b shows a microfluidic device includes two fluid inlets, a fluid outlet, and a serpentine segment of open channel. To produce a device capable of mixing two fluid streams at low Reynolds number, a serpentine channel geometry that induces mixing between two co-flowing liquids into the paper was employed (FIG. 9, panel b). Two separate fluid streams (0.05% solutions of Tartrazine or Methylene Blue in water) entered through a Y-junction at a flow rate of 10 μL/min. As illustrated in FIG. 9, panel d, when aqueous solutions (water dyed different colors for purposes of illustration) are introduced at each of the fluid inlets, the streams of dyed water flowing through the microfluidic channel mix when passing through the serpentine segment of open channel.

Repeating C-shaped units turn the fluid through 180° to induce chaotic advection and passively enhance the mixing of the streams. Thus in the region close to the inlet (see upper inset), two clearly delineated blue and yellow co-flowing liquid streams are observed that then became a single stream of green liquid 18 mm downstream from the inlet (see lower inset) (FIG. 9, panel d). The mechanism for inducing chaotic advection is the consecutive generation of Dean vortices in the curved microchannel.

Twist-Type Valves

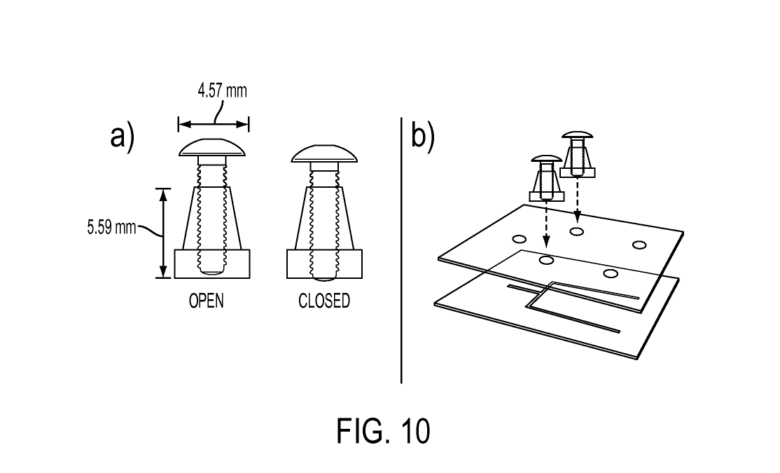

An exemplary strategy for integrating twist-type valves into the open channel devices is illustrated in FIG. 10. Open channel devices were fabricated by etching, as described above. 1 mm holes were cut through the adhesive tape over the microfluidic channel at points where a valve was to be placed. Valves were fabricated from flangeless ferules (P-200NX, Upchurch Scientific, Oak Harbor, Wash., USA) and small machine screws. A very small amount of PDMS (˜10 μl) was added to the bottom part of the screw and was allowed to cure forming a soft “cushion”. Rings of double-sided tape, also cut by the craft cutter, were used to fix the flangeless ferrules over the designated holes. The machine screws were then inserted into the ferrules (panel b).

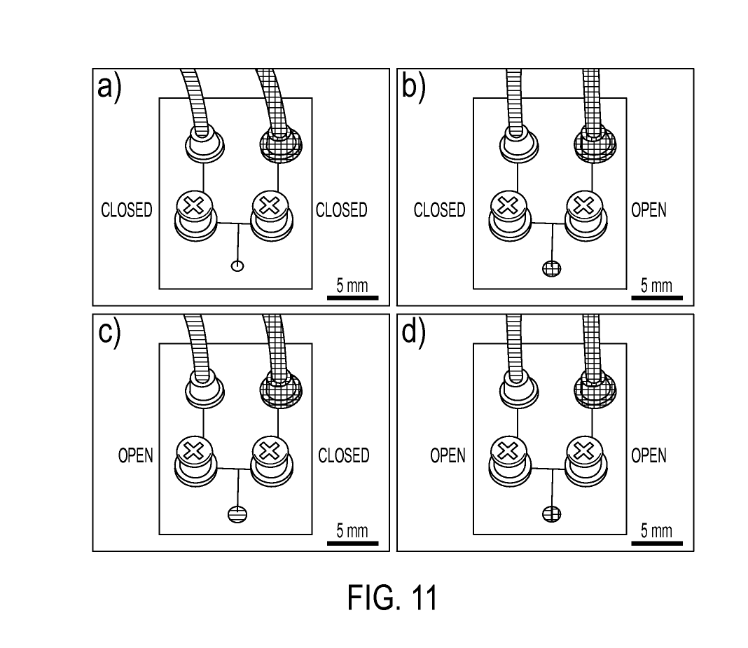

As illustrated in FIG. 10, panel a, when the screw is turned clockwise, the screw is lowered through the hole in the layer of tape and presses into the cardstock layer through the PDMS cushion, closing the valve and blocking the channel. For example, FIG. 1, panel a, illustrates the flow of the microfluidic device with both twist valves in the closed position. No fluid flows through the valves to reach the fluid outlet. FIG. 1, panel b, illustrates the flow of the microfluidic device with the left valve in the closed position and the right valve in the open position. Only the fluid injected through the right fluid flows reaches the fluid outlet. FIG. 11, panel c, illustrates the flow of the microfluidic device with the right valve in the closed position and the left valve in the open position. Only the fluid injected through the left fluid flows reaches the fluid outlet. As shown in FIG. 1, panel d, when both twist valves are in the open position, both fluids reach the fluid outlet

Fold Valves

Open channel devices incorporating fold valves were also prepared. These ‘fold’ valves reduce the flow rate through the microfluidic channel when the paper device is folded along an axis perpendicular to the fluid flow and provide simple solutions to controlling flows in elementary systems.

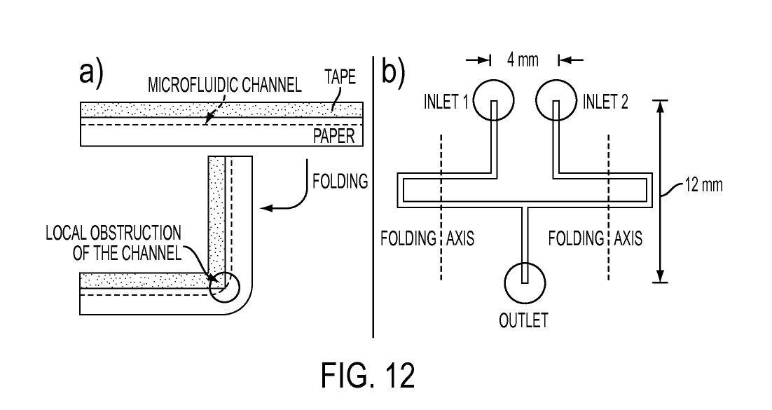

The open channel devices were fabricated using the etching process, and include two fluid inlets and a fluid outlet. The layout of an exemplary device is illustrated in FIG. 12, panel b. As shown in FIG. 12, panel b, each open channels was designed to possess a ‘U-shaped’ segment extending from the device, such that the segment can be bisected by a line (the folding axis) perpendicular to the fluid flow path that does not intersect any other portion of the microfluidic segment. The microfluidic device could therefore be folded, such that the fold crosses the U-shaped segment of the open channel, forming a fold valve. When folded out of plane, the open channel is locally obstructed at the point of the fold, altering fluid flow through the channel (FIG. 12, panel a).

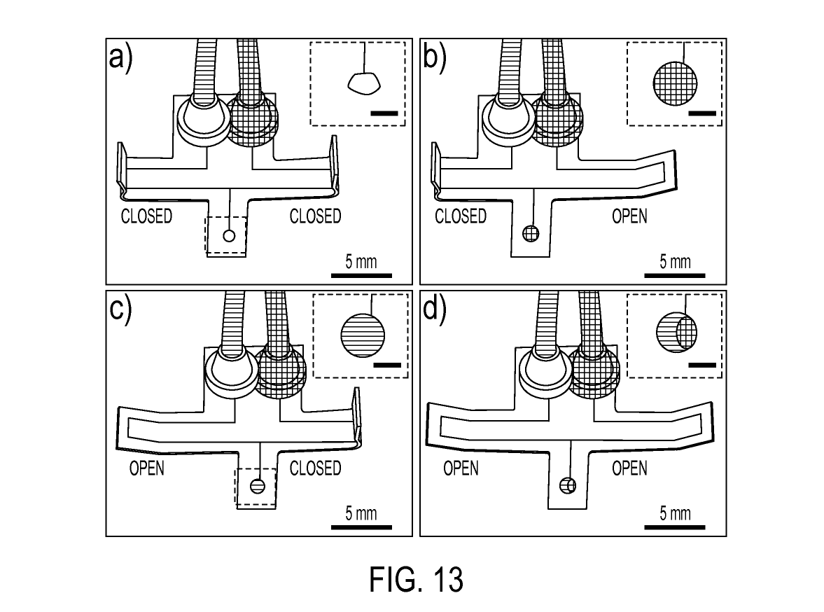

FIG. 13, panel a, illustrates the flow of the microfluidic device with both fold valves in the closed position. No fluid flows through the valves to reach the fluid outlet. FIG. 13, panel b, illustrates the flow of the microfluidic device with the left fold valve in the closed position and the right fold valve in the open position. Only the fluid injected through the right fluid flows reaches the fluid outlet. FIG. 13, panel c, illustrates the flow of the microfluidic device with the right fold valve in the closed position and the left fold valve in the open position. Only the fluid injected through the left fluid flows reaches the fluid outlet. As shown in FIG. 13, panel d, when both fold valves are in the open position, both fluids reach the fluid outlet.

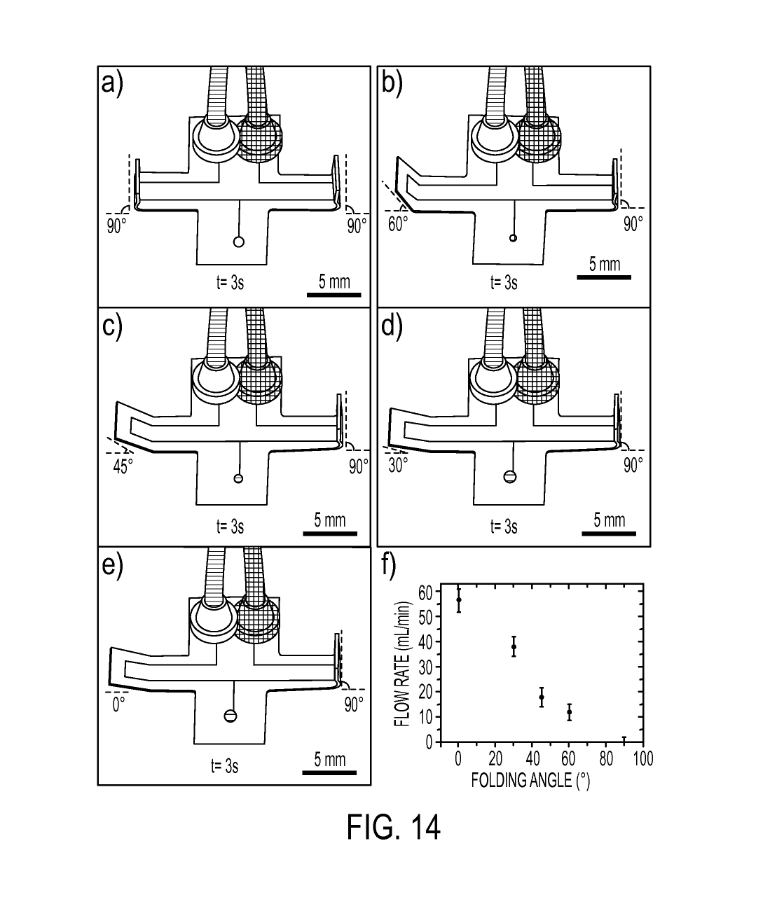

The fold valve was characterized by measuring the amount of liquid expelled from the outlet as a function of the dihedral angle of the folded paper making up this valve. As shown in FIG. 1143, the flow rate through a microfluidic device containing fold valves can be varied by changing the dihedral angle of the fold valve. The height of the fluid reservoir was adjusted to obtain a steady flow of ˜20 μL per minute for the unfolded device. Then, the dihedral angle was changed while simultaneously wiping away any excess fluid at the outlet. After sixty seconds, a calibrated micropipette collected and measured the volume of liquid expelled as a function of the dihedral angle. In panels a-e of FIG. 14, the folding angle for the right channel fold valve was maintained at 90°. The left fold valve was then adjusted to different angles of folding: panel a) 90°, panel b) 60°, panel c) 45°, panel d) 30°, panel e) 0°. Increasing the dihedral angle resulted in a continuous decrease in the amount of liquid expelled at the outlet, until an angle of 90° when no liquid was expelled at the outlet. FIG. 14, panel f, illustrates the relationship between the dihedral angle at the crease, and the amount of liquid expelled at the outlet. As shown in FIG. 14, panel f, flow rate (mL/min) varies as a function of the dihedral folding angle of the fold valve.

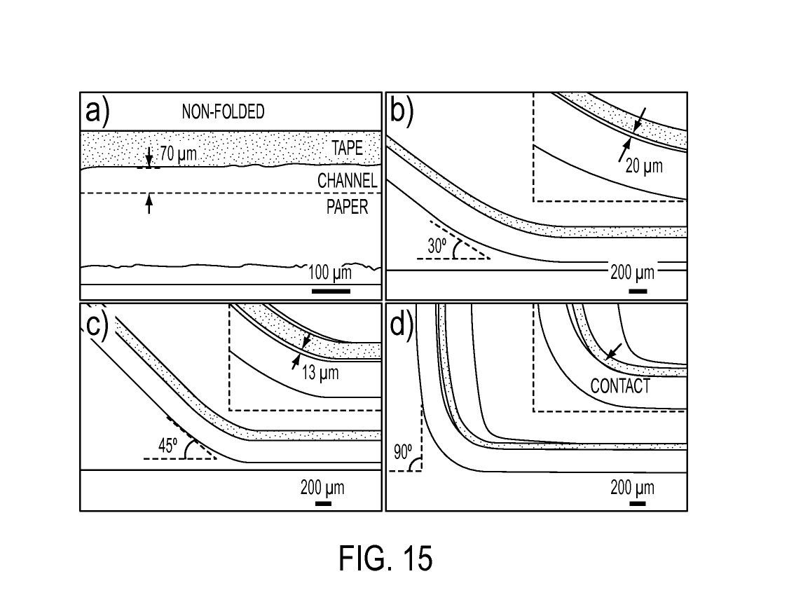

Unfolding the crease restored the flow along the fluid path. Each valve could be closed/opened at least ten times. Although we have not characterized the mechanism by which this valve operates in detail, we speculate that the tape constricts the channel as the paper is creased (see FIG. 12, panel a), and decreases the rate of flow through the channel. The fold valve is expected to be able to withstand a pressure of ˜27 kPa before failing through delamination or permeation of liquid into the porous hydrophobic matrix. FIG. 15, panels a-d, are SEM photomicrographs showing the interaction of the tape cover sheet and the paper channel at 0°, 30°, 45° and 90° of bend.

Porous Water Valves

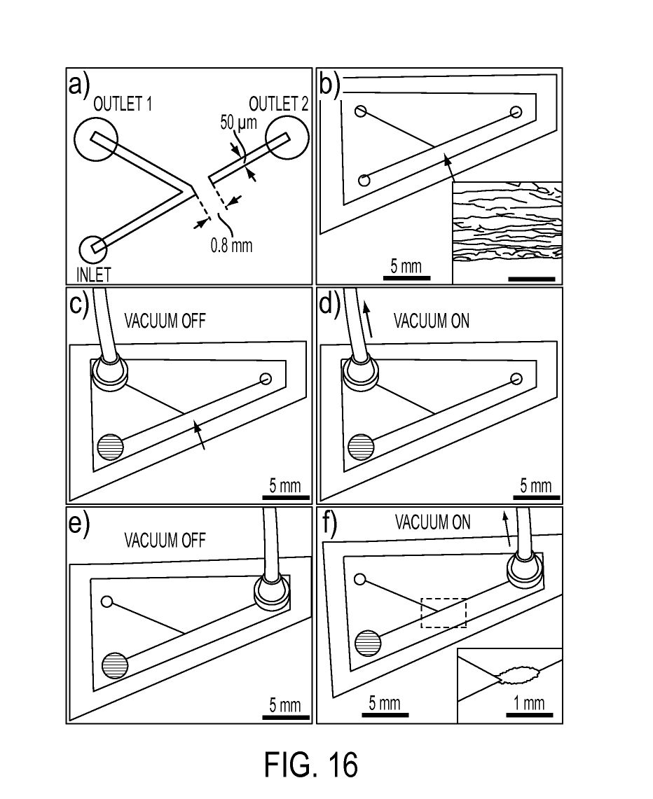

An exemplary open channel device incorporating a porous water valve was also prepared which can be used as a switch between different microfluidic channels. A schematic diagram illustrating the layout of a porous water valve is shown in FIG. 16, panel a. The device contains a ‘V-shaped’ channel and a straight channel separated by a narrow region of porous substrate. The device includes a single fluid inlet and two fluid outlets.

FIG. 16, panel a, shows a diagram of a microfluidic device that uses a pressure-dependent porous switch to direct water into one of two different paths depending on values of pressure. Two nonintersecting channels were designed such that the shortest distance between the fluid paths was 0.8 mm. FIG. 16, panel a, shows a water valve according to the diagram. Both sides of the device were sealed with gas-impermeable tape to allow the application of a vacuum through the paper channel (the paper devices discussed in the previous sections were sealed with tape on only one side) and placed a drop of an aqueous solution of dye at the inlet of the first channel to serve as a reservoir. Application of a vacuum at outlet 1 caused the water to flow from the inlet to this outlet. Application of a vacuum at outlet 2 changed the flow path: when the vacuum reached a threshold pressure (˜300±30 Torr or ˜40 kPa), the water passed through the hydrophobic pores in the region separating the two channels (FIG. 16, panels e and f) and the fluid followed the path from the inlet to outlet 2. This pressure difference represents the threshold pressure required for water to overcome both the surface free energy and resistance to flow through the pores of cardstock paper functionalized with C₁₀^{F}. The “bulge” at the crossing over between channels is consistently observed across a range of distances L and threshold pressures P. In this way, the porous water valve allows fluid flow to be switched between microfluidic channels.

### Example 4

### Gas Transfer within Open Channel Microfluidic Devices

Paper—a fibrous matrix containing a network of interconnected pores—generally exhibits much higher permeability to gas than the solid materials used to fabricate microfluidic devices. It is, for example, more than 100 times more permeable to oxygen than PDMS, which is itself unusually permeable. Paper exhibits relatively high gas permeability (approximately 80,000 Barrer for Whatman #50 paper, oxygen), while PDMS exhibits a gas permeability of approximately 600 Barrer (oxygen).

As a result, gas transport can occur rapidly (<1s) between parallel open microfluidic channels in a microfluidic device fabricated from paper. The high permeability of paper was used to enable rapid gas transport between two parallel microfluidic channels, the first of which contained a solution of dissolved HCl or NH₃, while the second contained an indicator for the volatile compound present in the first channel.

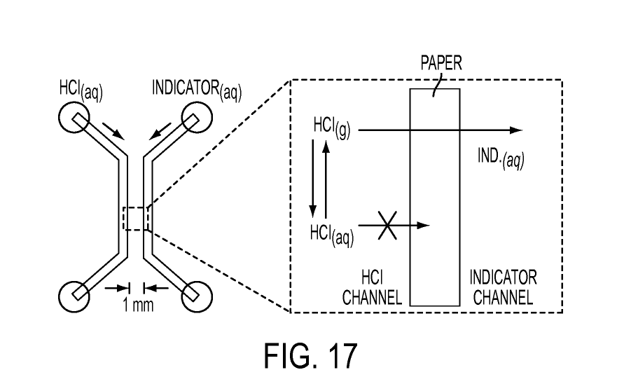

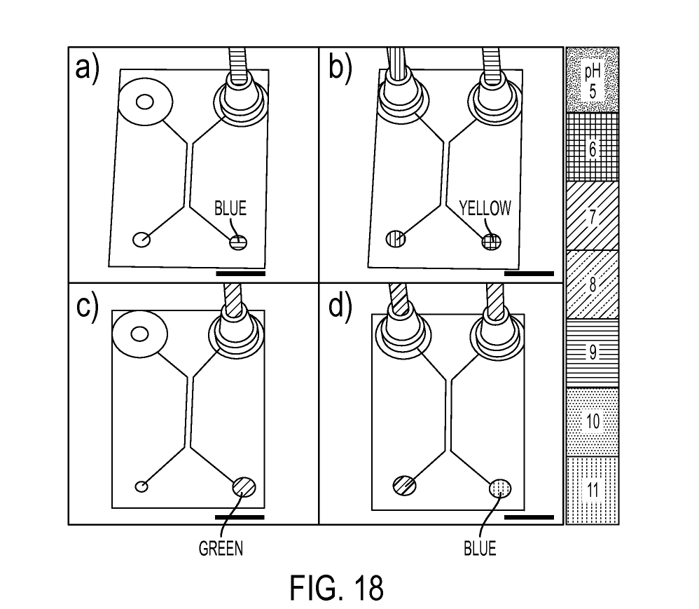

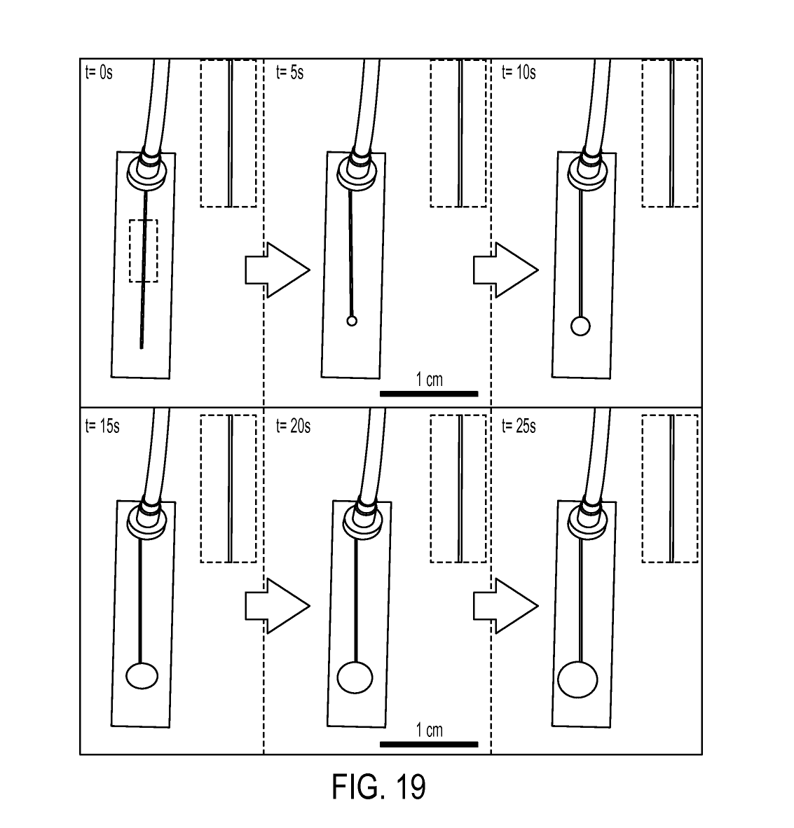

FIG. 17 schematically illustrates the design of a microfluidic device with two parallel open channels, the first of which contains a gas-water solution, and the second of which contains a sensor for the gaseous compound present in the first channel. The two channels are separated by a distance of approximately 1 mm at a point within the device at which their fluid flow paths run parallel to one another. Gas transfer from the gas-water solution to the second channel (containing the indicator) can occur by diffusion of the gas through the cellulosic substrate. Saturated aqueous solutions of dissolved HCl or NH₃ (37% and 28%, respectively) were passed through one channel, which was parallel to a second channel containing a solution of universal pH indicator (FIG. 18, panel a). The devices were sealed with gas-impermeable tape on both sides; the vapors of the acid or base (HCl or NH₃) diffused through the walls of the microfluidic device and changed the pH of the solution in the neighboring channel. The diffusion of HCl(g) from one channel to the other was visualized as a change in the color of the pH indicator in the parallel channel from blue (in panel a) to yellow (from pH 9 to pH 5. FIG. 18, panel b), while the diffusion of NH₃(g) was visualized as a change in the color of the pH indicator from green (in panel c) to blue (from pH 7 to pH 10, FIG. 18, panel d). These color changes occurred within less than a second of the liquids filling the channels.

The characteristic time needed for the gas molecules to diffuse from one channel to the other (in one-dimension) can be estimated by Eq. 4, where c is time (s), L is the length over which diffusion occurs, and D_{eff} is the effective diffusion constant of molecules of gas.

τ˜L²/2D_{eff} (4)

Based on the estimated porosity of cardstock paper, ε˜0.3 (See Supplementary Information), D_{eff} of NH₃ can be approximated as ˜10⁶ m²/s (See Supplementary Information). For a distance L=1 mm between parallel channels and D_{eff}=10⁻⁶ m²/s for NH₃, τ is 0.5 s, which is consistent with the rapid change in color we observed experimentally.

To verify that the change of pH was due to the diffusion of vapor between channels, and that no transfer of liquid occurred, the same procedure was repeated using aqueous solutions of a non-volatile acid (37% H₂SO₄) or base (8% NaOH, which has the same pH=13.6 as the 28% solution of ammonia). The non-volatile species caused no observable color change to the solution of pH indicator in the neighboring channel. Separate tests showed that the omniphobic paper generated by functionalization with a fluoroalkane (C₁₀^{F}) resists wetting by concentrated solutions of HCl, H₂SO₄, NH₃, or NaOH applied on its surface for more than two hours.

The high gas permeability of paper also allows for the removal of gas contaminants and unintended air bubbles from liquid samples flowing through an open channel microfluidic device. To demonstrate this principle, a series of plugs of an aqueous solution of blue dye separated by air bubbles (ranging in size up to 80 μL) are flowed through an open channel microfluidic device. At a flow rate of 25 μL/s, the air is expelled through the paper membrane, and the bubbles are not visible in the fluid flowing through the microfluidic channel. The flow of the aqueous phase in the channel is uninterrupted. See FIG. 19, which is a series of time-lapsed photographs showing the passage of a fluid along the open channel with no observation of air bubbles.

### Example 5

### Fabrication of Closed Channel Microfluidic Devices from Hydrophobic Paper

A closed channel microfluidic device was fabricated from a porous, hydrophilic substrate (paper), a cellulosic substrate that was covalently modified to increase its hydrophobicity (Whatmann #1 filter paper silanized by reaction with perfluorooctyl trichlorosilane (FOTS) vapor), and a cover (Scotch® tape).

First, the porous, hydrophilic substrate was patterned to form the shape of the closed channel using a laser cutter. The patterned porous, hydrophilic substrate was then placed one top of Whatmann #1 filter paper previously rendered hydrophobic by silanization with perfluorooctyl trichlorosilane (FOTS) vapor. The patterned porous, hydrophilic substrate and the cellulosic substrate were then covered by transparent cellotape.

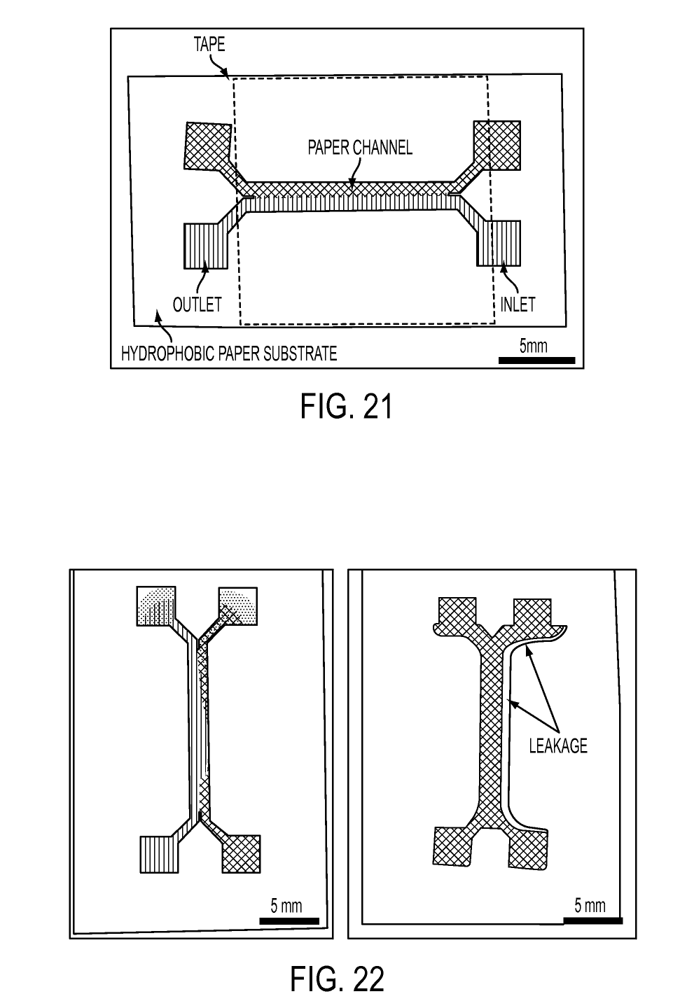

The resulting closed channel microfluidic device is shown in FIG. 21. The region of the device covered by cellotape is indicated by the dotted lines superimposed on FIG. 21. Fluids placed at the fluid inlets move through the closed channel through wicking and without leakage.

The covalently modified paper serves as a barrier to confine fluids to flow through the closed channel without any leakage (FIG. 21 and FIG. 22, left). In contrast, similar closed channel microfluidic devices fabricated using a plastic substrate (office transparency film, FIG. 22, right) exhibited leakage of fluid from the closed channel into the gap between the plastic substrate and the transparent tape cover.

### Example 6

### Fabrication of a Microwell Plates from Hydrophobic Paper

A multi-well plate was constructed by embossing a plurality of microwells on Whatmann #1 filter paper.

For purposes of initial investigation, a 96-well plate of similar dimensions to a conventional 96-well plate was fabricated. Two polymeric dies of complementary shape and appropriate design (i.e., a positive and negative mold) were fabricated using a 3D printer. The microwell was then fabricated by sandwiching a sheet of paper (Whatmann #1 filter paper) between the polymeric dies, and applying pressure using a rubber mallet to emboss the paper.

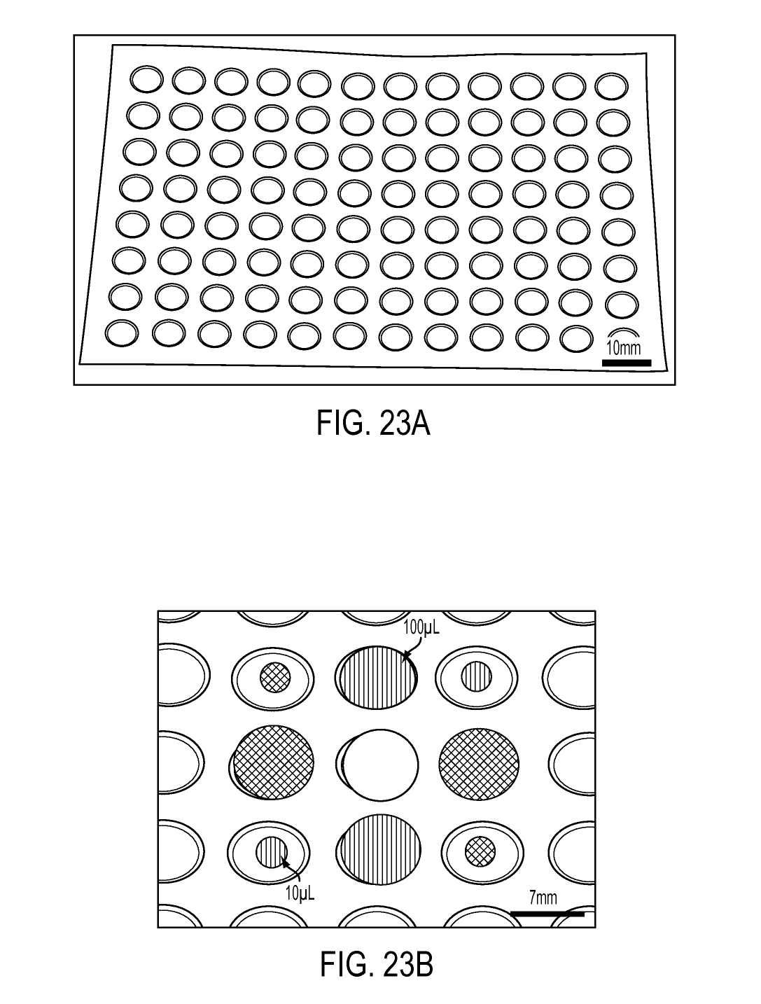

FIG. 23A shows a photograph of a 96-well paper plate. Each well in the 96-well paper plate has a diameter of 6.9 mm and a depth of −0.5 mm. As shown in FIG. 23B, each well can hold up to 100 μL of an aqueous solution.

### Example 7

### Fabrication of 3-Dimensional (3D) Open Channel Microfluidic Devices

3D open channel microfluidic systems were constructed using covalently modified paper and double-sided tape. Complicated 3D devices could be readily fabricated by stacking layers of covalently modified paper and double-sided tape. Using this methodology, 3D open channel microfluidic devices can be fabricated in high yield with good reproducibility, stackable (adaptable) structure, uniform geometry, tunable channel dimensions, and predictable properties.

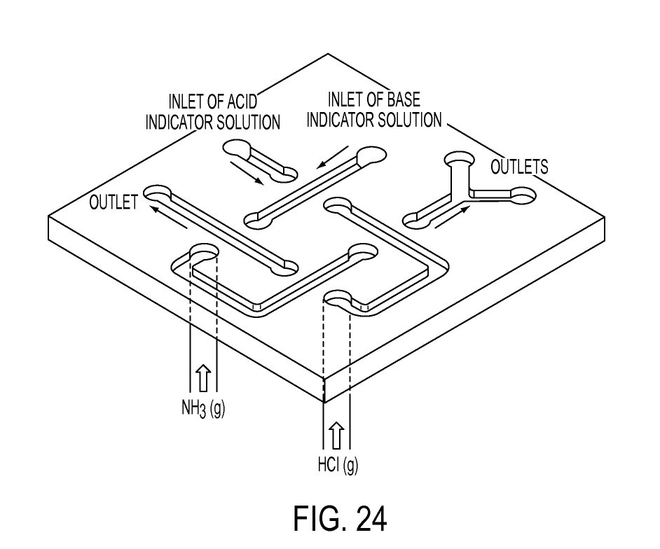

To demonstrate this principle, a 3D open channel microfluidic device containing two open microfluidic channels crossing each other multiple times without mixing was fabricated using covalently modified paper (see FIG. 24). The exemplary device was fabricated with microfluidic channels approximately 2 mm wide and 80 mm long. The device contained two fluid inlets for aqueous indicator solutions, two inlets for gas-phase reagents, and three fluid outlets.

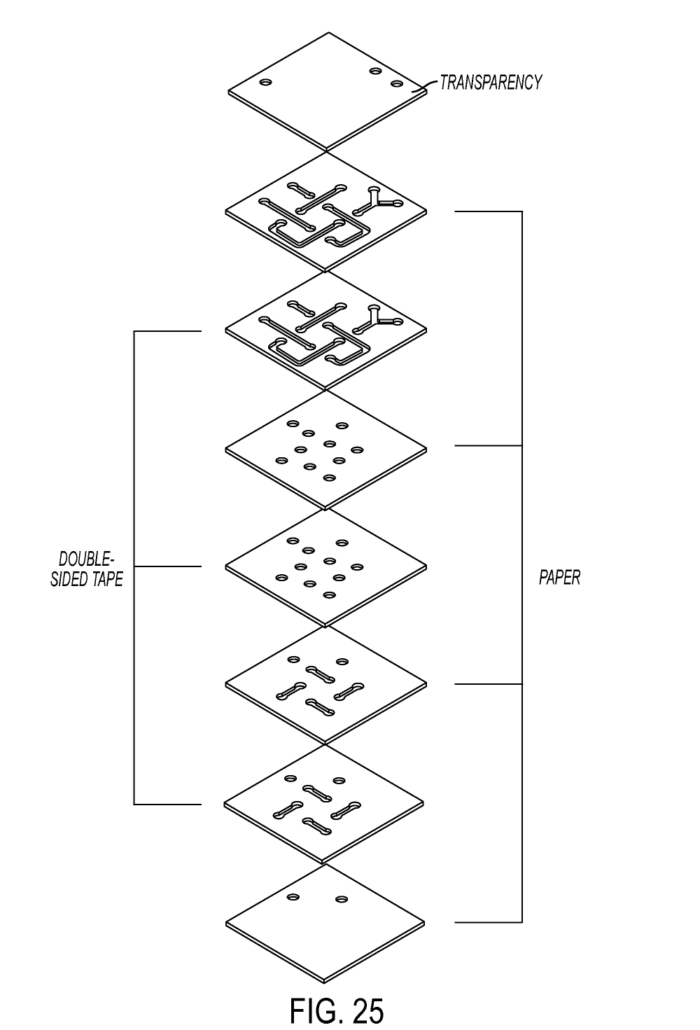

The device was fabricated from multiple layers of double-sided tape and Whatman chromatography paper. FIG. 25 schematically illustrates the layout of each layer making up the 3D microfluidic device. To form the device, double-sided tape (3M Scotch® carpet tape) was attached to a sheet of Whatman chromatography paper No. 1 with one face of tape still protected with a layer of film. The pre-designed pattern was cut through the paper and tape using a laser cutter (Universal Laser VL-300 50 Watt Versa Laser), with the stroke setting of 0.05 pt.

The patterned layers were placed on top of each other, and joined together via the double-layer tape. The assembled devices were then put into a desiccator for covalent modification via silanization with perfluorooctyl trichlorosilane. Perfluorooctyl trichlorosilane solution was placed at the bottom of desiccator, and a vacuum was applied to vaporize the silane and saturate the atmosphere within the desiccator. The reaction of hydroxyl groups on the surface of paper with vapor of silanes readily occurs at room temperature. The microfluidic device is fully hydrophobic after leaving it under silane vapors overnight (the cellulosic substrate was reacted for approximately 15 hours).

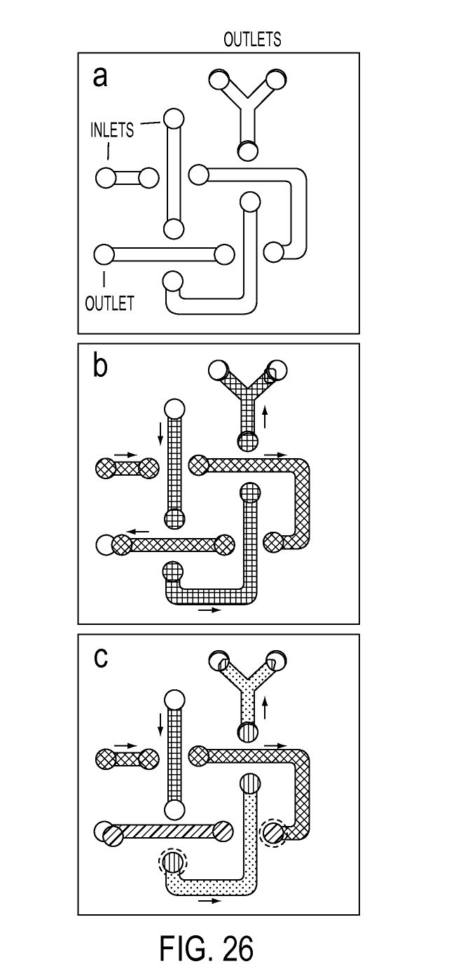

The front of the silanized microfluidic device was then covered with transparent tape. Two fluid inlets were attached to the front of the device, and two gas inlets to the back of the device. The inlets were supported by PDMS slabs using double-sided tape. The completed device is shown in FIG. 26, panel a. The two fluid inlets are located on the top left part of the device.

Two illustrate device performance of the device, two aqueous pH indicator solutions (light grey—phenol red; black—bromophenol blue sodium salt) were introduced into the open channels via the fluid inlets (FIG. 26, panel b). The device then distributed solutions both laterally and vertically from the fluid inlets to the fluid outlets. The droplets at the fluid outlets (FIG. 26, panel b) indicate that the device enables streams of fluid to cross one another multiple times without mixing.

Selective areas of the bottom side of the two open channels (indicated by the dotted circles) were then connected to sources of fuming HCl(g) and NH₃(g) through polyethylene tubing (FIG. 26, panel c). The gases diffused through the bottom paper layer into the channels containing the indicator solution, got dissolved into the solution, and changed the solution pH and color, producing a colorimetric response. The gas permeable paper provides a simple and reliable way of analyzing gases, while the gas impermeable double-sided tape in the microfluidic device prevents gas from penetrating into unwanted zones. As a result, multiple gas samples can be independently analyzed. By adjusting the fluid flow rate and/or the thickness of the bottom layer of paper in the microfluidic device, the kinetics of colorimetric change and gas diffusion rate could be varied.

### Example 8

### Use of Microfluidic Devices in Paper as Serial Diluters and Droplet Generators

One of the useful characteristics of open-channel PDMS microfluidics is the ability to precisely generate monodisperse microdroplets of immiscible fluids, or well-defined gradients of solutes in miscible liquids. The precise control over volumes and concentration conferred by droplet-based microfluidics has led to new avenues of development in chemical and biochemical screening, protein crystallization, enzymatic kinetics, and bioassays.

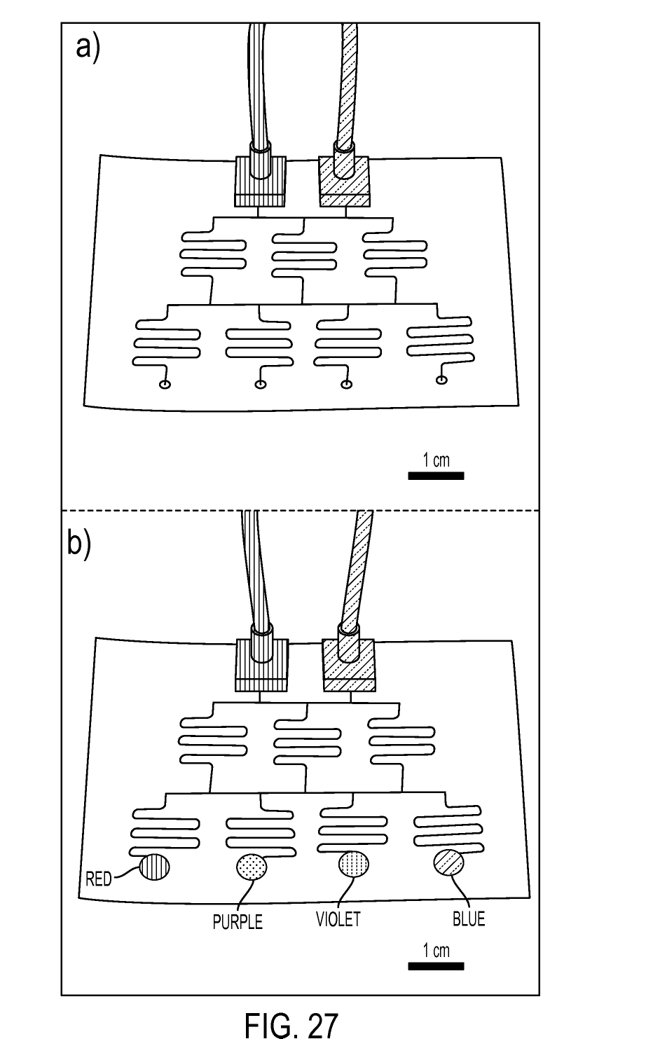

Treated paper devices paper were fabricated to provide inexpensive devices for performing serial dilutions, and for generating droplets in an immiscible phase. FIG. 27, panels a and b, shows the serial dilution of an aqueous solution of 0.05% Methylene Blue with a solution of 0.05% Congo Red. Both solutions were provided to their respective inlets at a flow rate of 10 μL/min (using a syringe pump). The serial dilution can be visualized as a change in the color of liquids inside the channels and at the outlets, from red and blue to shades of purple.

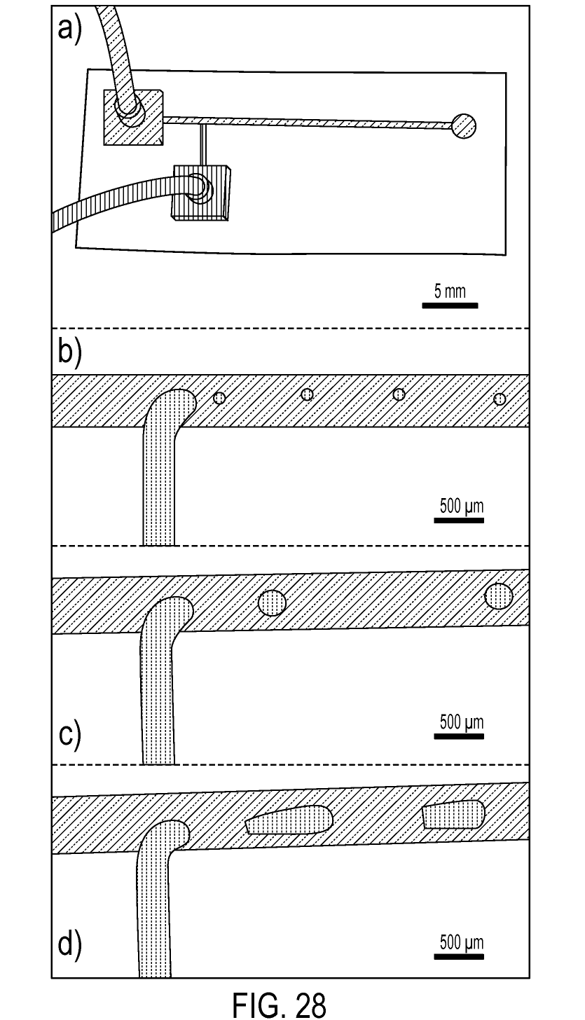

FIG. 28, panels a through d, shows the formation of droplets in a T-junction in a paper microfluidic device. Fluid flows continuously (here hexadecane dyed with Sudan Blue) along the main channel, and the fluid that will be dispersed (here water dyed with 0.05% Congo Red) is added via an orthogonal inlet. Silanization with C₁₀^{F} prevents wetting of the surface by liquids with surface tensions as low as 27 mN/m, such as hexadecane, which here serves as the “carrier” fluid, or continuous phase. The dispersed phase is an aqueous solution of dye (0.05% Congo Red). The flow of the aqueous solution and the oil was established with syringe pumps. These two phases met at a junction, where the competition between viscous shear stresses acting to deform the liquid interface and capillary pressure acting to resist the deformation caused the droplets to “pinch off” by a free surface instability. The local flow field that deforms the interface is determined by the geometry of the junction and the flow rates of the two fluids. The paper microfluidic device with engraved channels (˜300×200 μm² cross sectional dimensions) can generate uniformly sized droplets generated at frequencies between 0.5-10 Hz. For different rates of flow of continuous and dispersed fluid, Qₒᵢₗ and Q_{water} the device can generate aqueous droplets of different lengths L (defined as the distance between the furthest downstream and upstream points along the interface of a fully detached immiscible plug).

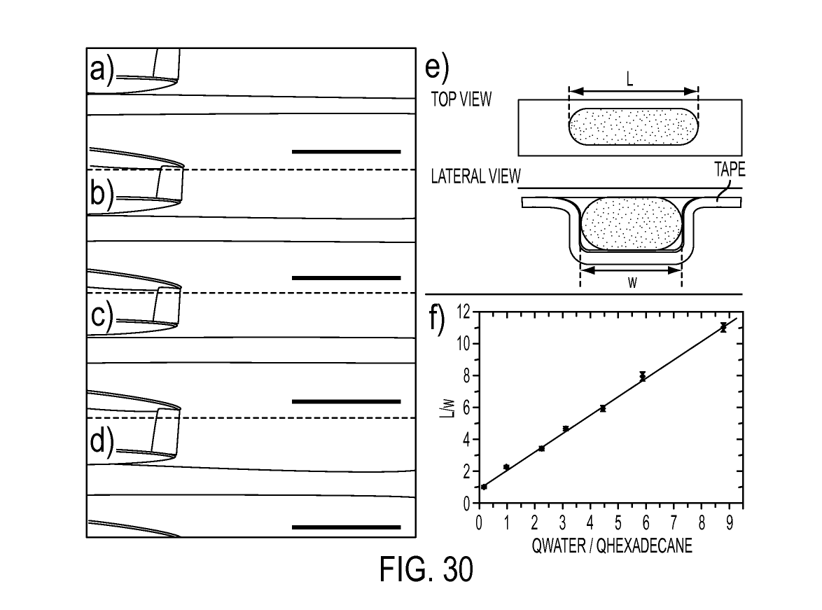

FIG. 28, panels a through d, shows that the T-junction permits active control over droplet size distribution by adjusting the relative flow rates of the continuous and disperse phases. As the volume of a droplet is proportional to the volumetric flow rate of the dispersed phase, we formed droplets of various sizes by varying the flow rate of the aqueous solution while keeping the flow rate of the continuous phase constant. FIG. 28, panels a through d, illustrates this dependence and shows several representative micrographs of the system at different flow rates of the continuous and dispersed phases. Representative micrographs of the system at different ratios of flow rates for the continuous and dispersed phase: FIG. 30, panel b, Qₒᵢₗ: Q_{water}=30, and L=˜40 μm, FIG. 28, panel c, Qₒᵢₗ:Q_{water}=8, and L=˜300 μm; FIG. 30, panel d, Qₒᵢₗ:Q_{water}=4, and L=˜600 μm.

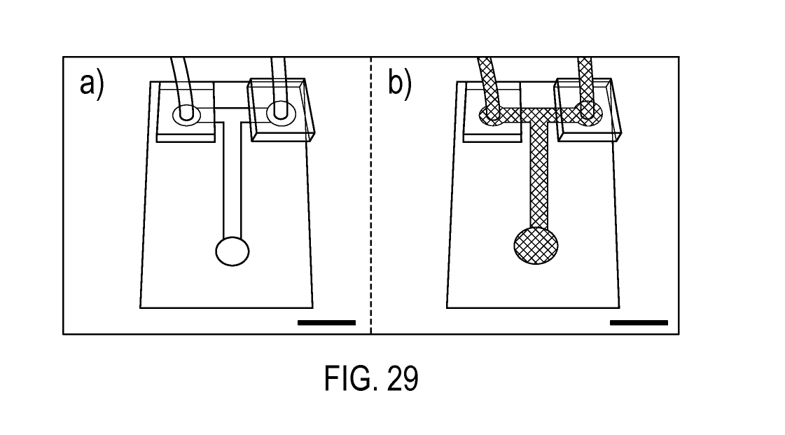

FIGS. 29 and 30 illustrate another implementation of this capability in an embossed open microfluidic channel. For different rates of flow of continuous and dispersed fluid, Q_{water} and Q_{hexadecane}, the device can generate aqueous droplets of different lengths L (defined as the distance between the furthest downstream and upstream points along the interface of a fully detached immiscible plug). The coefficient L/w (where w is the width of the channel) can be modified by controlling the speed of the flow of hexadecane (Q_{hexadecane}) or water (Q_{water}) as shown in FIG. 30.

### Example 9

### Investigation into Products Formed on Incineration of Treated Paper

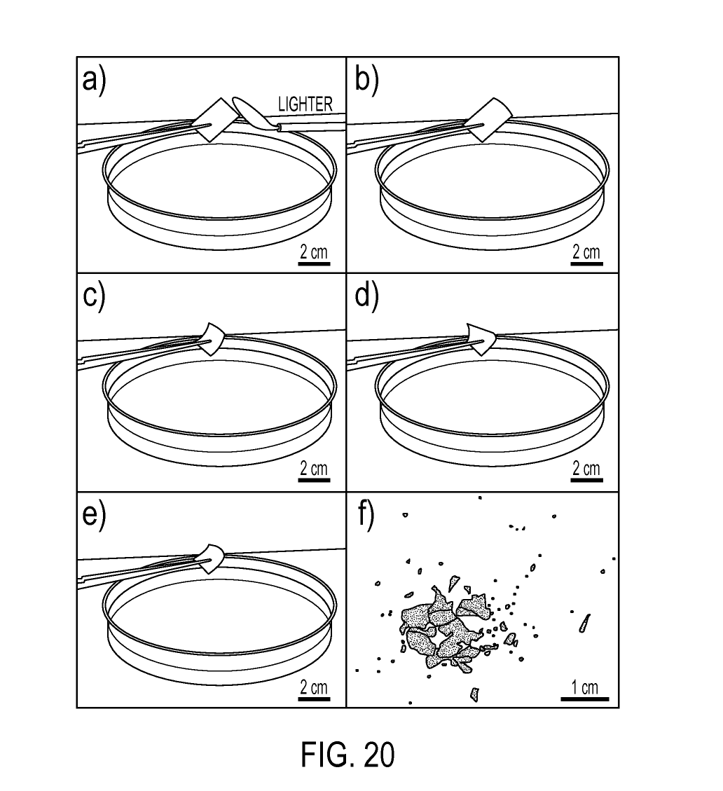

Bioanalytical devices fabricated using silanized paper can be disposed of by incineration. The elemental analysis of the fluorinated papers, suggests that the incineration of a 1 cm² device at T<1500° C. can produce at most 34 μg of a perfluoroalkyl carboxylic acid; under more stringent conditions (temperatures above 1500° C.), this content of fluorine could lead to the formation of a maximum of ca. 29 μg of HF, or a maximum of ca. 49 μg of COF₂. FIG. 20 is a demonstration of burning a device assembled from a layer of hydrophobic paper functionalized with C₁₀^{F} and tape (PET/EVA/LDPE).

Combustion of fluoroalkanes occurs at temperatures above 1500° C. under atmospheric pressure. The distribution of products includes COF₂, CF₄, CO, and CO₂, with COF₂ and CO₂ being the most abundant when the combustion occurs with 20% O₂. The toxic volatile compounds, COF₂ and HF, have threshold limits for short-term exposure of 2 ppm (5.4 mg/m³) for COF₂ and 2 ppm (1.7 mg/m³) for HF.

If the omniphobic paper is burned in a simple set-up, with no high-temperature combustion catalyst present in the system when the paper is burned, the temperature of the flame is likely not high enough to allow the decomposition of the fluoroalkyl chains. It is, however, sufficiently high to allow the breaking of the C—Si bond and the oxidation of the terminal carbon atom to yield terminally oxidized fluoroalkyl species.

Unless defined otherwise, all technical and scientific terms used herein have the same meanings as commonly understood by one of skill in the art to which the disclosed invention belongs. Publications cited herein and the materials for which they are cited are specifically incorporated by reference.

Those skilled in the art will recognize, or be able to ascertain using no more than routine experimentation, many equivalents to the specific embodiments of the invention described herein. Such equivalents are intended to be encompassed by the following claims.

We claim:

1. An open channel microfluidic device comprising:
a device having a bottom and two side walls that define an open channel for receiving fluid, wherein the bottom and side walls of the open channel are formed from a hydrophobic cellulosic substrate, wherein the cellulosic substrate has been covalently modified to increase its hydrophobicity.

2. A closed channel microfluidic device comprising:
a closed channel formed from a porous hydrophilic substrate, said closed channel defining a fluid flow path, wherein at least one face of the closed channel is bounded by a hydrophobic cellulosic substrate that has been covalently modified to increase its hydrophobicity, and wherein the porous hydrophilic substrate and the hydrophobic cellulosic substrate are separate layers of substrate material which are abutted to one another.

3. The device of claim 1, wherein the covalent modification is selected from the group consisting of hydrocarbon and perfluorocarbon moieties.

4. The device of claim 1, wherein the cellulosic substrate is selected from the group consisting of paper, cellulose derivatives, woven cellulosic materials, and non-woven cellulosic materials.

5. The device of claim 4, wherein the paper is selected from the group consisting of chromatography paper, card stock, filter paper, vellum paper, printing paper, wrapping paper, ledger paper, bank paper, bond paper, blotting paper, drawing paper, fish paper, tissue paper, paper towel, wax paper, and photography paper.

6. The device of claim 5, wherein the paper has a grammage of greater than 75 g/m².

7. The device of claim 1, wherein the hydrophobic cellulosic substrate has a contact angle with water of greater than about 90 degrees, more preferably greater than about 100 degrees.

8. The device of claim 1, wherein the open channel has a width of less than about 3 mm, more preferably less than about 1 mm, more preferably less than about 700 microns, most preferably less than about 300 microns.

9. The device of claim 1, wherein the open channel has a depth of less than about 1 mm, more preferably less than about 500 microns, most preferably less than about 100 microns.

10. The device of claim 1, further comprising a cover.

11. The device of claim 10, wherein the cover is formed from a hydrophobic material selected from the group consisting of polymer, fabric, plastic, metal, and combinations thereof.

12. The device of claim 1, further comprising one or more fluid inlets.

13. The device of claim 1, further comprising one or more valves.

14. The device of claim 1, wherein the bottom and two side walls of the channel are cut into the substrate.

15. The device of claim 1, wherein the bottom and two side walls of the channel are embossed into the substrate.

16. The device of claim 1, wherein the hydrophobic cellulosic substrate is folded or creased to alter fluid flow through the open channel.

17. The device of claim 1, wherein the channel is curvilinear in shape.

18. The device of claim 1, further comprising a region designed to mix one or more fluids in the channel.

19. The device of claim 1, wherein the device comprises two channels spaced apart from each other at a selected distance for a portion of each channel, said distance selected to provide a fluid pathway between the portions of each channel at fluid flow pressure above a threshold pressure

20. The device of claim 2, wherein the bottom of the closed channel is formed from a cellulosic substrate that has been covalently modified to increase its hydrophobicity.

21. The device of claim 2, wherein the side walls of the closed channel are formed from a cellulosic substrate that has been covalently modified to increase its hydrophobicity.

22. The device of claim 2, wherein the top of the closed channel is formed from a cellulosic substrate that has been covalently modified to increase its hydrophobicity.

23. The device of claim 2, wherein the bottom, side walls, or top of the closed channel are formed from a hydrophobic material selected from the group consisting of paper, fabric, plastic, metal, and combinations thereof.

24. The device of claim 1, further comprising one or more assay regions fluidly connected to the channel, wherein one or more of the assay regions comprise an assay reagent.

25. The device of claim 24, wherein the assay reagent is selected to react to the presence of an analyte selected from the group consisting of small molecules, proteins, lipids, polysaccharides, nucleic acids, prokaryotic cells, eukaryotic cells, particles, viruses, metal ions, and combinations thereof.

26. A method of making the open channel microfluidic device of claim 1, comprising
a. covalently modifying a cellulosic substrate with one or more hydrophobic reagents, and
b. forming an open channel in the substrate.

27. The method of claim 26, wherein the open channel is formed by embossing, stamping, impressing, carving, creasing, folding, stacking, or etching the substrate.

28. The method of claim 26, further comprising applying one or more assay reagents to the device.

29. The method of claim 26, further comprising attaching one or more valves, fluid inlets, or combinations thereof to the device.

30. The method of claim 26, further comprising folding or creasing the substrate across one or more locations along the channel.

31. A method of analyzing a sample comprising introducing the sample into the microfluidic device of claim 1.

32. The method of claim 31, wherein the sample is an aqueous solution or suspension.

33. The method of claim 31, wherein the sample is a biological fluid.

34. The method of claim 31, wherein the presence, quantity, or combination thereof of an analyte in the sample is indicated by observing, measuring, or combinations thereof one or more assay regions of the device.

35. The method of claim 34, wherein an assay reagent is selected to react to the presence of an analyte selected from the group consisting of small molecules, proteins, lipids, polysaccharides, nucleic acids, prokaryotic cells, eukaryotic cells, particles, viruses, metal ions, and combinations thereof.

36. A method of making the closed channel microfluidic device of claim 2, comprising
a. patterning a porous hydrophilic medium to form the shape of the closed channel, and
b. embedding the porous hydrophilic medium on or within a cellulosic substrate covalently modified to increase its hydrophobicity.

37. The method of claim 36, further comprising applying one or more assay reagents to the device.

38. The method of claim 36, further comprising attaching one or more fluid inlets to the device.

39. A multi-well plate comprising a plurality of wells, wherein the wells are formed from a cellulosic substrate covalently modified to increase its hydrophobicity.

40. The plate of claim 39, wherein the cellulosic substrate is selected from the group consisting of paper, woven cellulosic fabrics, and non-woven cellulosic fabrics.

41. The plate of claim 39, wherein the paper is selected from the group consisting of chromatography paper, card stock, filter paper, vellum paper, printing paper, wrapping paper, ledger paper, bank paper, bond paper, blotting paper, drawing paper, fish paper, tissue paper, paper towel, wax paper, and photography paper.

42. The plate of claim 39, wherein the hydrophobic cellulosic substrate has a contact angle with water of greater than about 90 degrees, more preferably greater than about 100 degrees.

43. The plate of claim 39, wherein the wells have a width of less than about 10 mm, more preferably less than about 7 mm, more preferably less than about 5 mm, most preferably less than about 3 mm.

44. The plate of claim 39, further comprising one or more assay reagents within one or more wells of the plate.

45. The plate of claim 44, wherein the assay reagents are selected to react to the presence of an analyte selected from the group consisting of small molecules, proteins, lipids, polysaccharides, nucleic acids, prokaryotic cells, eukaryotic cells, particles, viruses, metal ions, and combinations thereof.

46. A method of making the plate of claim 39, comprising
a. covalently modifying a cellulosic substrate with one or more hydrophobic reagents, and
b. forming a plurality of wells or channels in the substrate.

47. The method of claim 46, wherein the wells are formed by embossing, stamping, impressing, carving, or etching the substrate.

48. The method of claim 46, further comprising applying one or more assay reagents to the plate.

49. The device of claim 2, wherein the covalent modification is selected from the group consisting of hydrocarbon and perfluorocarbon moieties.

50. The device of claim 2, wherein the cellulosic substrate is selected from the group consisting of paper, cellulose derivatives, woven cellulosic materials, and non-woven cellulosic materials.

51. The device of claim 50, wherein the paper is selected from the group consisting of chromatography paper, card stock, filter paper, vellum paper, printing paper, wrapping paper, ledger paper, bank paper, bond paper, blotting paper, drawing paper, fish paper, tissue paper, paper towel, wax paper, and photography paper.

52. The device of claim 51, wherein the paper has a grammage of greater than 75 g/m².

53. The device of claim 2, wherein the hydrophobic cellulosic substrate has a contact angle with water of greater than about 90 degrees, more preferably greater than about 100 degrees.

54. The device of claim 2, further comprising one or more assay regions fluidly connected to the channel, wherein one or more of the assay regions comprise an assay reagent.

55. The device of claim 54, wherein the assay reagent is selected to react to the presence of an analyte selected from the group consisting of small molecules, proteins, lipids, polysaccharides, nucleic acids, prokaryotic cells, eukaryotic cells, particles, viruses, metal ions, and combinations thereof.

56. A method of analyzing a sample comprising introducing the sample into the microfluidic device of claim 2.

57. The method of claim 56, wherein the sample is an aqueous solution or suspension.

58. The method of claim 56, wherein the sample is a biological fluid.

59. The method of claim 56, wherein the presence, quantity, or combination thereof of an analyte in the sample is indicated by observing, measuring, or combinations thereof one or more assay regions of the device.

60. The method of claim 59, wherein an assay reagent is selected to react to the presence of an analyte selected from the group consisting of small molecules, proteins, lipids, polysaccharides, nucleic acids, prokaryotic cells, eukaryotic cells, particles, viruses, metal ions, and combinations thereof.
